(19) United States
(12) Patent Application Publication
(10) Pub. No.: US 2024/0265028 A1
(43) Pub. Date: Aug. 8, 2024

(54) Processing Structured Data for Real-time Segmentation

(71) Applicant: Ab Initio Technology LLC, Lexington, MA (US)

(72) Inventors: Joel Gould, Arlington, MA (US); Benjamin James Robbie Roche, London (GB); Matthew John Banks, Farnham (GB)

(21) Appl. No.: 18/486,300

(22) Filed: Oct. 13, 2023

Related U.S. Application Data
(60) Provisional application No. 63/443,295, filed on Feb. 3, 2023.

(51) Int. Cl. G06F 16/25; H04L 67/55

(52) U.S. Cl. CPC G06F 16/258; H04L 67/55

(57) ABSTRACT

A method for performing real-time segmentation by updating a wide record based on receipt of real-time data, wherein an item of real-time data represents a transaction, detecting that the updated wide record satisfies criteria for performing real-time segmentation, and performing real-time segmentation on the updated, wide record, wherein real-time is relative to when a transaction represented in the updated wide record occurs.

### CLAIM OF PRIORITY

This application claims priority under 35 U.S.C. § 119(e) to U.S. Patent Application Ser. No. 63/443,295, filed on Feb. 23, 2023, the entire contents of which are hereby incorporated by reference.

### BACKGROUND

This disclosure relates to techniques for efficiently operating a data processing system with many datasets that may be stored in any of a large number of data stores.

Modern data processing systems manage vast amounts of data within an enterprise. A large institution, for example, may have millions of datasets. These datasets can support multiple aspects of the operation of the enterprise. Complex data processing systems typically process data in multiple stages, with the results produced by one stage being fed into the next stage. The overall flow of information through such systems may be described in terms of a directed dataflow graph, with nodes or vertices in the graph representing components (either data files or processes), and the links or “edges” in the graph indicating flows of data between the components. A system for executing such graph-based computations is described in U.S. Pat. No. 5,966,072, titled “Executing Computations Expressed as Graphs,” incorporated herein by reference.

Graphs also can be used to invoke computations directly. Graphs made in accordance with this system provide methods for getting information into and out of individual processes represented by graph components, for moving information between the processes, and for defining a running order for the processes. Systems that invoke these graphs include algorithms that choose inter-process communication methods and algorithms that schedule process execution and provide for monitoring of the execution of the graph.

To support a wide range of functions, a data processing system may execute applications, whether to implement routine processes or to extract insights from the datasets. The applications may be programmed to access the data stores to read and write data.

### SUMMARY

In a general aspect, process is implemented by a data processing system for performing real-time segmentation by updating a wide record based on receipt of real-time data. An item of real-time data represents a transaction. The process includes detecting that the updated wide record satisfies criteria for performing real-time segmentation, and performing real-time segmentation on the updated, wide record, wherein real-time is relative to when a transaction represented in the updated wide record occurs.

A segment is a collection of data that are associated with one or more attributes that define the collection of data as being distinct from one or more other collections of data. For example, a segment can specify that one or more records included in the segment are associated with the one or more attributes that define the segment. The one or more attributes can include data that describes an aspect of the data within the collection associated with the segment. For example, a segment may describe an entity associated with the key value of each record in the collection associated with the segment. In this example, a segment can include one or more attributes that describe a subscriber or a customer, the type of the data, or any other aspect of the data that can be described by one or more attributes. An attribute can include metadata describing other data with which the attributes are associated. For example, an attribute can include an age or time period associated with the data, a demographic of a subscriber, a range of values associated with the data, a type of the data, the format of the data, a time when data was transmitted or received, for any such example of a descriptive value, phrase, or keyword that describes other data.

A real-time segment includes an item of data that specifies a segment associated with a key value at the instant in time in which the real-time segment is generated. The real-time segment validly represents the segment with which the key value is associated within a threshold period of time of when the real-time segment is determined. Generally, real-time segments are not stored in persistent memory because the real-time segments are stale once additional real-time data are generated for the key value, which could change the segment to which the key value belongs. For example, a real-time segment may no longer be representative of the actual segment with which the key value is currently associated once additional transaction data are generated for that key value. Rather, it is possible that the key value is associated with a different segment that is yet to be calculated by the data processing system. The real-time segment is used in real-time or in near real-time relative to an instant in which transaction data are generated for a key value So that the segment that is determined represents the true current segment associated with the key value and not a stale segment that is outdated.

The data processing system is configured to determine the real-time segment within a threshold period of time after the transaction data for a key value are received at a real-time data source (such as a message bus). The data processing system is configured to act on updates to the data associated with a key value within the threshold period of time (in real-time or near real-time) before other data (such as additional transactions) are generated for the key value. The real-time segments enable the data processing system to determine, within the threshold period of time at which transaction data are generated for a key value, an action to perform based on an updated segment for that key value. The data processing system is therefore able to act when a key value is associated with a particular segment, even if the key value is only associated with the particular segment for a brief amount of time (e.g., after a single transaction during the day). The data processing system can also instantly act when a user enters a particular segment. For example, the data processing system can generate a message, alert, discount, or other data associated with the key value immediately responsive to transaction data being received in association with the key value. This can enable a user associated with the key value to be aware that the user has entered the segment, such as a preferred customer segment, responsive to a particular transaction.

Generally, a wide record includes data from a plurality of different data sources within a computing network. For example, the wide record can include one or more fields that are combined from a plurality of different data records. The data records can be obtained from same or different storage devices, same or different remote devices, and same or different data processing systems. The wide record generally includes data, obtained from a plurality of data records, that are relevant to a particular processing workflow. In some implementations, the wide record is generated responsive to a request for data in the data processing workflow. In some implementations, the wide record is generated in real-time responsive to the request. Data from each of batch storage and real-time data storage are used to determine the real-time segment for a key value as real-time data are generated for the key value. The wide record enables the data processing system to determine the real-time segment because the wide record includes both real-time data and batch data stored for a given key value. The data processing system can therefore determine, after a particular transaction occurs, the current segment associated with a key value responsive to that transaction occurring. The data processing system uses the wide record to determine the real-time segment associated with a key value within a threshold period of time of the transaction occurring, such as in real-time or near real-time.

Real-time or near real-time processing refers to a scenario in which received data are processed as made available to systems and devices requesting those data immediately (e.g., within milliseconds, tens of milliseconds, or hundreds of milliseconds) after the processing of those data are completed, without introducing data persistence or store-then-forward actions. In this context, a real-time system is configured to process a data stream as it arrives, and output results as quickly as possible (though processing latency may occur). Though data can be buffered between module interfaces in a pipelined architecture, each individual module operates on the most recent data available to it. The overall result is a workflow that, in a real-time context, receives a data stream and outputs processed data based on that data stream in a first-in, first out manner. However, non-real-time contexts are also possible, in which data are stored (either in memory or persistently) for processing later. In this context, modules of the data processing system do not necessarily operate on the most recent data available.

The process includes receiving, by the data processing system, one or more data items associated with a given key. The process includes detecting, in the one or more received data items, an occurrence of a transaction. The process includes, responsive to the detecting, accessing volatile memory that stores data records for a plurality of keys. The process includes retrieving, from the volatile memory, a data record for the given key. The process includes updating the data record with data in accordance with the one or more data items received specifying the occurrence of the transaction and being associated with the given key. The process includes executing one or more rules on the updated data record, with a rule being associated with a segment, with the rule specifying one or more conditions, and with the rule further specifying that upon satisfaction of the one or more conditions by a data item to associate that data item with the segment. The process includes, based on the executing, determining one or more segments associated with the updated data records, with determination of the one or more segments being in near real-time relative to the occurrence of the event. The process includes outputting, by the data processing system, instructions specifying one or more actions associated with the one or more segments determined.

Other aspects include computer systems and computer program products.

One or more of the above aspects may include amongst features described herein one or more of the following features.

In some implementations, the process includes generating a push notification to instruct a transaction processing system to update the data record associated with the given key when at least one segment associated with the given key changes from a previous segment.

In some implementations, the process includes receiving a request for a real-time segment associated with the given key as a service. In some implementations, the process includes in response to receiving the request and in real-time, sending the one or more segments associated with the updated data records to a system that sent the request.

In some implementations, the process includes providing a user interface for defining the one or more rules prior to determination of the one or more segments.

In some implementations, the instructions specifying one or more actions associated with the one or more segments determined comprise an offer that is exclusive to one of the one or more segments.

In some implementations, the process includes determining that the given key is associated with at least two segments. In some implementations, the process includes generating, based on the determining, instructions for performing, by a remote computing system, at least two actions.

In some implementations, the process includes updating the data record with data in accordance with the one or more data items received specifying the occurrence of the transaction that includes retrieving, from a data warehouse, a batch data record associated with the given key. In some implementations, the process includes generating a virtual record that includes at least a portion of the one or more data items received specifying the occurrence of the transaction and the batch data record associated with the given key. In some implementations, the process includes determining the one or more segments associated with the updated data records based on the virtual record.

One or more of the above aspects may provide one or more of the following advantages.

The data processing system is configured to calculate a real-time segments for entities associated with given keys. The real-time segments are instantaneous segments for the entities. The real-time segments represent segment(s) to which each entity or piece of data associated with the entity belongs at time in which the real-time segments are calculated. Computing systems, such as logistic systems, transaction processing systems (e.g., automated teller machines (ATMs) or point of sale (POS) machines), internet brokers, online storefronts, rewards engines, etc. can use the real-time segments immediately (in real-time) to determine a real-time action for performance by a computing system (e.g., mobile device) associated with the entity. The real-time action is responsive to the entity's status at the instant the segment of the entity is requested. The real-time segments are generated/updated by the data processing system between instances of a batch workflow execution. For example, the real-time segments are responsive intraday to transaction data such that a new segment is determined for each transaction associated with an entity as the transaction occurs. In some implementations, the real-time segment for an entity could be different for each subsequent item of transaction data of the entity processed by the data processing system. An entity may be a user or a technical process or apparatus. When referring to a “user” herein, the same statements apply equally to other kinds or entities.

A real-time segment for an entity can be provided by the data processing system as a service. For example, computing device (e.g., ATM, POS, etc.) may request the real-time segment for an entity while processing a transaction associated with the entity. When the computing system needs to know the entity's current segment, the data processing system is invoked to provide the current segment in real-time or near real-time in response to the request.

The data processing system can push a real-time segment to a computing device to indicate the current real-time segment of an entity has changed, indicating a different status for the entity. For example, an entity's aggregate spend for an account can pass a threshold value during a transaction represented in an item of transaction data. The entity now belongs to a new segment of users or entities whose aggregate spend is greater than the threshold value. The data processing system determines the updated segment for the entity in real-time as the entity's status is changed. The updated real-time segment of the entity can be sent to another computing system to provide a real-time notification to that computing device. The computing device, in real-time, can perform an action or generate an offer responsive to the change in segment associated with the entity. The computing device does not need to wait for the entity's segment to be updated during batch processing. The action can therefore be responsive to an entity's activity as the activity occurs intraday, or between periodic batch processing of the entity's segment.

The real-time segments do not need to be stored because they are stale once time passes. If the entity's real-time segment is needed again, the data processing system re-calculates the real-time segment that is current for the new request.

Processing that incorporates use of an entity's segment attribute is more accurate. The real-time segment represents an entity's true segment status, rather than a status of the entity when a batch process workflow was executed. In batch-based segmentation systems, the entity's segment attributes become increasingly inaccurate between batch processes. The batch segment is static until the batch process updates the segment. Transactions that are processed a longer period after the batch workflow execution (such as later in the day) do not incorporate the intraday results of previous transactions. The entity's batch segment is increasingly inaccurate as more transactions are processed for the entity and the batch segment is not updated.

The real-time segment is generated in an environment including batch processing and real-time processing. As described herein, separation of the batch and real-time module provides for efficient usage of memory resources. This is because, through the batch module, batch retrieval can be done once a day and be made available throughout the day through volatile memory, then the results of the batch retrieval can be supplemented with the real-time data. All incoming transaction data items are incorporated immediately into a segmentation in a manner that keeps latency associated with data retrieval low, which allows for an accurate and real-time segmentation process. The real-time data is stored in memory before it is committed to disk. So, rather than storing all the batch and real-time data in memory, memory only needs to store, e.g., the last 24 hours-worth of data and the rest of the transaction data for an entity needed for the real-time segment can be retrieved from disk, thereby decreasing consumption of memory.

The real-time segmentation described herein enables an entity to define multiple different segments for entities at the same time. An entity defines segments based on selections of different values in a supplied graphical user interface. The user can define multiple segments at the same time. The user can define an aggregate using many different sources of data from a data catalog at the same time. The definition (and execution) of multiple segments at the same time improves efficiency for both defining the real-time segments and for the generated logic that computes real-time segments in a data processing system. This is compared to an efficiency of defining and executing multiple segments in series.

Many systems can easily process a few datasets. However, as the number of datasets to be processed increases—to the millions of datasets, the complexity of processing these datasets also increases. This is because the efficient processing of large numbers of datasets requires a scalable system, which in turn requires optimization, logical access of data and systemic feedback, each of which is addressed below.

To achieve efficiency in data processing, dataflow graphs are optimized. A dataflow graph includes data processing components. Some data processing components have specified functionality—such as being pre-configured to perform a partition operation and a sort operation.

An example optimization is when an entity specifies that a particular component performs a partition and a sort. However, if a component preceding the particular component is configured for a partition and a sort, the computer program is optimized to not perform the operations of partitioning and sorting twice.

During optimization, memory resources are also efficiently allocated for increased efficiency in data processing by deleting from memory a data item that is no longer utilized by a dataflow graph. In particular, the data being processed by a dataflow graph is also stored, e.g., in volatile memory or virtualized memory. However, not all components of a dataflow graph need to access or use all items of data. For example, an upstream component may utilize an item of data, but the downstream component may not. In this example, the data processing system is configured to identify when an item of data is not utilized by downstream components and to delete or otherwise remove that data item from memory, thereby reducing memory usage, e.g., relative to memory usage of saving all data items until completion of the dataflow graph.

The data processing system described herein is configured to process data items in real-time workflows independent of data pre-processing. Rather, the data processing system is configured to process data that is processed in a batch or real-time workflow to generate a data record including the relevant data that is useful real-time calculation, such as segmentation. By streaming these data items into memory, the data processing system can provide live time responses (using segmentation) to transactions (events) as they occur. The memory includes a volatile memory in the real-time workflow that stores these data items. For example, data that are not relevant to the performance of real-time segmentation are removed from the transaction data and attributes data of a keyed data record. Instead, a record is generated with the needed data for processing by a segmentation engine. The data processing system is configured to allow a near immediate or live time segmentation that is response to content, such as transactions (events), of data records associated with an identifier as they are received and to segment data for the same identifier, which also provides for near immediate or live time visibility of application results for this identifier.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system.

FIG. 2 is a block diagram of a system.

FIGS. 3A-3C are diagrams of the system of FIG. 2 in stages of just-in-time segmentation definition.

FIG. 3D shows an example of a virtual record for generation of a real-time segment.

FIGS. 4A-4C are diagrams of the system of FIG. 2 in stages of just-in-time segmentation in which real-time segments are generated.

FIGS. 5A-5C are diagrams of the system of FIG. 2 in stages of just-in-time segmentation definition including a control for real-time or batch segmentation.

FIG. 6 is a flow diagram depicting just-in-time segmentation in which real-time segments are generated.

FIG. 7 is a flow diagram depicting just-in-time segmentation in which real-time segments are generated.

FIGS. 8A-8D are diagrams depicting user interfaces.

FIG. 9 is a diagram showing details of a computer system, such as a data processing system.

### DETAILED DESCRIPTION

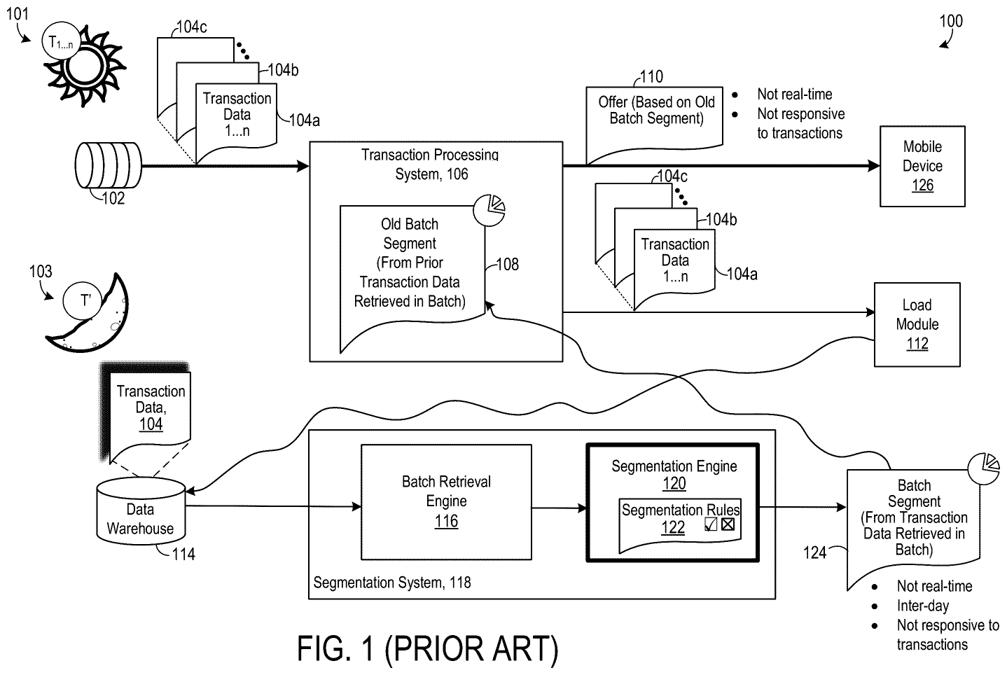

FIG. 1 shows a system 100 that includes a transaction processing system 106 configured to process transaction data 104a-c (collectively transaction data 104) and determine a segment 108 that is related to the processed transaction data 104. The transaction processing system 106 receives a stream of items of transaction data 104a-c from a real-time data source 102 in a real-time workflow 101. The real-time workflow 101 operates continuously or approximately continuously (such as during the day) as transactions are performed. The transactions data 104 represent data processing transactions that are occurring. As the data processing transactions (also called events) are occurring, the transactions data 104 are generated (e.g., by another computing system, not shown) to represent those transactions.

The transactions represented by the transactions data 104 can require some action to be performed in real-time or near-real-time responsive to the transaction. For example, if an entity performs an action with a computing device, such as making a payment, putting money in an account, sending a text message, making a call, or any other event, a computing system (such as mobile device 126) related to the event may need to determine a segment to which the user belongs. The computing system 126, based on the segment, can present a desired offer or action to the user as part of processing the transaction. The computing system 126, in real-time or near real-time with respect to the occurrence of the transaction or as part of processing the transaction, determines the action to perform based on determining the segment 108 to which the user belongs.

The transaction processing system 106, based on the determined segment 108 for an item of the transaction data 104a-c, determines what offer or action 110 to take with respect to the item of transaction data 104a-c that is being processed. For example, the transaction processing system 106 can specify an action that is performed for a customer, subscriber, user, and so forth associated with the item of the transaction data 104a-c. The transaction process system 106 sends the data including the specified action or offer 110 to a remote device, such as a mobile device 126, associated with the owner of the item of transaction data 104a-c. For example, the mobile device 126 can perform a first action or offer based on the user belonging to a first segment or perform a second action or offer based on the user belonging to a second segment that is different from the first segment.

Real-time or near real-time processing refers to a scenario in which received data are processed as made available to systems and devices requesting those data immediately (e.g., within milliseconds, tens of milliseconds, or hundreds of milliseconds) after the processing of those data are completed, without introducing data persistence or store-then-forward actions. In this context, a real-time system is configured to process a data stream as it arrives, and output results as quickly as possible (though processing latency may occur). Though data can be buffered between module interfaces in a pipelined architecture, each individual module operates on the most recent data available to it. The overall result is a workflow that, in a real-time context, receives a data stream and outputs processed data based on that data stream in a first-in, first out manner. However, non-real-time contexts are also possible, in which data are stored (either in memory or persistently) for processing later. In this context, modules of the data processing system do not necessarily operate on the most recent data available.

To process the transaction data 104, the transaction processing system 106 retrieves the segment 108 from a batch process workflow 103. A segmentation system 118 in a batch process workflow 103 periodically (e.g., once per day) processes the batch transaction data 104 to determine the batch segment definitions 124 for users, computing systems, customers, subscribers, and so forth. A batch retrieval engine 116 of the segmentation system 118 retrieves the transaction data 104. The transaction data 104 is retrieved in batch so that the segmentation engine 120 can define segments for the set of users based on all the transaction data 104 (and other data, if applicable) processed so far.

The segmentation engine 120 defines segments 124 (including segment 108) for a set of indexes (e.g., representing the users, subscribers, computing systems, etc.). The segmentation engine 120 defines the batch segments 124 based on a set of segmentation rules 122. The segmentation rules include logic that associates users with segments based on one or more attributes associated with the user.

Though the real-time workflow 101 is configured for processing transaction data 104 in real-time, the segment 108 is an old segment that is determined based on batch data of the batch workflow 103. Therefore, the segment 108 is not a real-time segment. The segment 108 is updated only when the batch workflow 103 executes (e.g., once per day). The transaction processing system 106, when processing items of the transaction data 104a-c, cannot access updated segments between instances of the batch workflow 103 executing. The segment 108 is static between updates by the batch workflow 103. For example, if several items of transaction data 104 are related to a particular user that is assigned a given segment 108 during the day, each item of transaction data 104 is processed based on that segment for the user. The segment for that user cannot update during the day, even if the segment for that user would change based on prior items of transaction data 104a-c processed during that day. Rather, the items of transaction data 104a-c are sent to a load module 112. The load module 112 sends the items of transaction data 104 processed during the day in the real-time workflow 101 to a data storage, such as a data warehouse 114. The items of transaction data 104 are then processed in batch by the batch workflow 103 for periodically updating the segments (e.g., once per day).

The system 100 is not processing items of transaction data 104a-c based on real-time segments. The segment 108 is only updated when the batch workflow 103 executes. The offers 110 and actions generated by the transaction processing system 106 are not real-time offers or actions. The offers or actions 110 are not responsive to the values in the items of the transaction data 104a-c. In addition, the segments 124 generated are not responsive to inter-day processing by the real-time workflow 101. The offers or actions 110 generated can be stale, repetitive, outdated, or incorrect as the period elapses between instances of batch workflow 103 execution. For example, if the batch workflow 103 executes once per day, actions or offers 110 that are generated earlier in the day are more accurate than offers or actions generated later in the day.

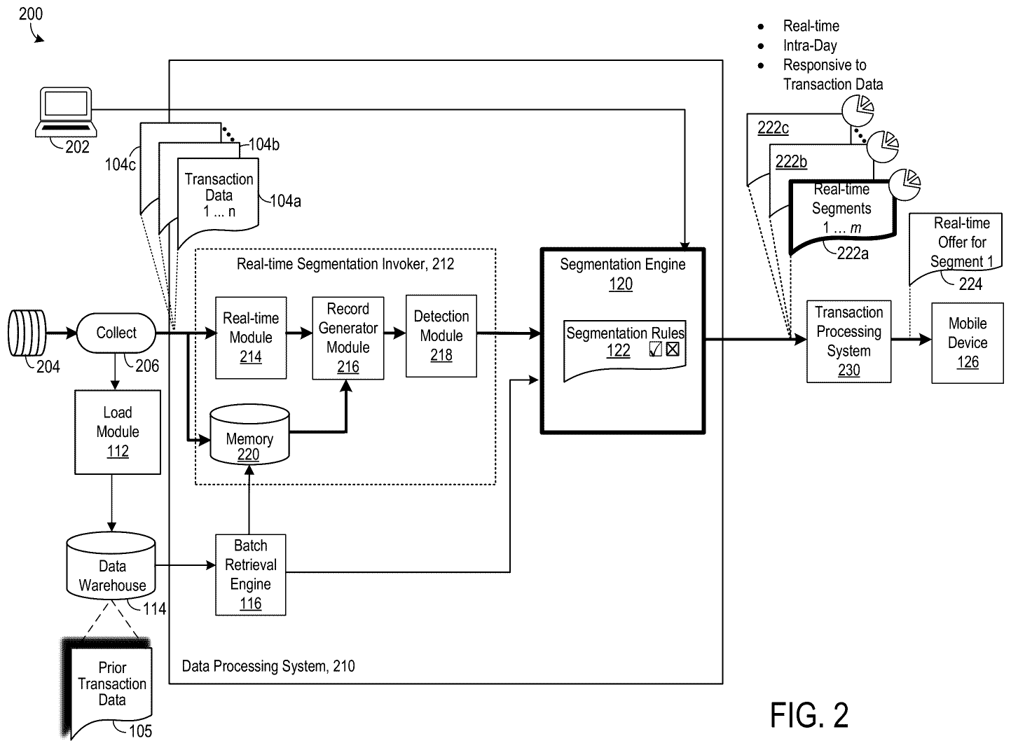

FIG. 2 is a block diagram of a system 200 that performs just-in-time segmentation. Just-in-time segmentation includes generating a segment for an entity in real-time in response to a request for an entity's segment. A data processing system 210 receives items of transaction data 104 in a stream from a real-time data source 204. The real-time data source 204 can include a message bus 204 that receives real-time data, such as transaction data 302, as a stream in real-time as the real-time data are generated by one or more remote devices. For example, as transactions occur at point-of-sale systems, the generated transaction data can be streamed to the real-time data source 204. The real-time data is available from the real-time data source 204 for a period of time (such as two days). The collect module 206 or other systems can subscribe to one or more fields of real-time data from the real-time data source 204. by subscribing to the one or more fields of the real-time data source 204, the collect module 206 or other systems receive the corresponding real-time data of the one or more fields as a stream in real-time as these data are available at the message bus.

Additionally, the data processing system 210 receives prior batch transaction data 105 from the data warehouse 114, such as once per day, from the warehouse 114. The prior batch data 105 are part of the batch data that are stored in persistent memory (such as the data warehouse 114) and are therefore available for a period of time longer than that of the real-time data at the real-time data source 204.

In the prior art of FIG. 1, the batch retrieval engine 116 performs a batch access to the transaction data 104 at the warehouse 114 once at the beginning of the working hours of each day and the segment calculated at the start of the day determines which actions are instructed. The other transaction data 104a-c incoming during the rest of the day are stored in the warehouse 114 by load module 112 and do not cause an adjustment of the segments and/or new actions within the same day. Only the next day, the transaction data of the previous day are batch retrieved again from the warehouse 114 to adjust the segments and/or new actions being instructed.

By contrast, in the system of FIG. 2 the data processing system 210 is configured to calculate a real-time segment 222a-c (collectively real-time segments 222) for users at essentially any time within a given time period, such as one day. More typically, the segments are calculated in real-time or near real-time such that a segment for an entity is updated immediately responsive to a transaction. The real-time segments are instantaneous segments for the entities. The real-time segments represent segment(s) to which each user belongs when the real-time segments 222 are calculated. Computing systems, such as transaction processing system 230, can use the real-time segments 222 immediately (in real-time) to determine a real-time action or offer 224 for performance by a computing system associated with the user, such as the mobile device 126. The real-time offer 224 is therefore responsive to the user's status at the instant the segment of the user is requested. The real-time segments 222 can therefore be generated/updated by the data processing system 210 between instances of a batch workflow execution. For example, the real-time segments 222 are responsive intraday to transaction data 104. In some implementations, the real-time segment 222a-c for an entity could be different (updated) for each item of transaction data 104a-c of the user processed by the data processing system 210.

The request for the user's real-time segment may occur in various scenarios. The user's real-time segment 222 can be provided by the data processing system 210 as a service. For example, a computing system (such as the mobile device 126) may request the segment of an entity while processing a transaction associated with the user. When the computing system needs to know the user's current segment, the data processing system 210 is invoked to provide the current segment in real-time or near real-time in response to the request. The segment is not only accessed in real-time by the data processing system 210. Rather, the data processing system 210 calculates the segment of the user in real-time based on the status of the user, incorporating any transaction data 104 or other attributes associated with the user that are updated in real-time. The real-time segments 222a-c represent the instantaneous segments associated with users. The real-time segments 222a-c are used in real-time by the computing system that requested them, such as mobile device 126. The real-time segments 222 do not need to be stored because they are stale once time passes. If the user's real-time segment is needed again, the data processing system 210 re-calculates the real-time segment that is current for the new request.

The data processing system 210 can generate the real-time segments 222 as transaction data 104 are processed. The data processing system 210 can generate a real-time segment 222a-c without a request from the transaction processing system 230. Rather, when an entity's segment changes, the data processing system 210 can push the updated real-time segment 222a-c to the transaction processing system 230 to cause an offer or action 224 instruction to be generated by the transaction processing system 230. In this example, the transaction processing system 230 receives the real-time segment 222a-c. Responsive to receiving the real-time segment 222a-c, the transaction processing system 230 executes a process to determine if an offer or action instruction 224 is to be generated based on the new segment.

An example of pushing a real-time segment is now described. An entity's aggregate spend for an account can pass a threshold value during a transaction represented in an item of transaction data 104a-c. The user now belongs to a new segment of users whose aggregate spend is greater than the threshold value. In the system 100 of FIG. 1, the user's segment is not updated until the batch workflow 103 executes and updates the batch segments 124 for the users. Only after the batch workflow 103 executes is the user's new segment accurate for subsequent transactions. The system 200, in contrast, calculates the segment for the user in real-time, based on the previously received item(s) of transaction data 104a-c for the user during the day. The segmentation engine 120 of the data processing system 210 calculates a real-time segment 222a-c of the user that accurately represents the user's new segment 222a. For example, the new segment 222a specifies that the user is in the segment of users whose aggregate spend exceeds the threshold value. The data processing system 210 sends the real-time segment 222a to the transaction processing system 230, which detects that the user's real-time segment has changed. The transaction processing system 230 generates the offer 224 for the user, who now qualifies for the offer by being in the segment of users with the required aggregate spend. For example, when the user spends enough money on a rewards credit card, the transaction processing system 230 can generate an offer immediately when the user's aggregate spend value exceeds a specified 30-day threshold (or satisfies any other metric defined in the segmentation rules 122). The offer is generated in real-time responsive to the transaction that changed the user's segment, rather than after a period of time passes. This can enable a computing system, such as a point-of-sale system, to generate a real-time discount or reward for an entity based on which segment the user is in at that given instant.

The data processing system 210 receives items of transaction data 104 from a real-time data source 204. The data processing system 210 receives prior transaction data 105 from a data warehouse 114. The prior transaction data 105 represent transaction data stored in batch. A batch retrieval engine 116 accesses the data warehouse 114 to obtain relevant prior transaction data 105 (e.g., associated with the user identified in an item of transaction data 104a-c). The data processing system 210 loads the prior transaction data 105 into memory so that the transaction data 105 are available for real-time processing in the real-time segmentation invoker 212.

A collect module 206 collects the items of transaction data 104a-c for loading into the data warehouse 114 by the load module 112. These transaction data 104 items are combined with the prior transaction data 105 in a batch update process (e.g., once per day). The collect module 206 collects the transaction data 104 as it is generated on the real-time data source 204 and prepares the transaction data for the batch load into the data warehouse 114. The collect module 206 also forwards the transaction data to the real-time segmentation invoker 212 for processing in the real-time workflow. The transactions data 104 are therefore available as prior transaction data 105 for a following time period after the batch load (e.g., the next day), while the transaction data 104 are processed by the real-time segmentation invoker 212 and the segmentation engine 120 to update the real-time segments in real-time. If needed, the data processing system 200 can process the prior transaction data 105 to generate batch segments (e.g., for collections of entities) in addition to the real-time segments that are generated on a per-entity basis.

The real-time segmentation invoker 212 is configured to access the real-time transaction data 104 and prior transaction data 105 and determine whether a real-time segment is to be generated. The real-time segmentation invoker 212 accesses the transaction data 104a-c items with a real-time module 214 that receives the transaction data 104 items. The real-time segmentation invoker 212 accesses a volatile memory 220 storing prior transaction data 105 and relevant user attributes. The real-time segmentation invoker 212 identifies an entity associated with the transaction data 104a-c item being processed. The real-time segmentation invoker 212 accesses attributes associated with the user, as subsequently described.

The real-time segmentation invoker 212 generates, by a record generator module 216, a record associated with the item of transaction data 104a-c being processed. The record includes all relevant data for the user for determining a real-time segment of the user. For example, the record generated by the module 216 includes user attributes, prior transaction data 105 for the user, and current transaction data 104a-c items received for the user. The user can be identified based on data included in the item of transaction data 104a-c being processed. For example, each user can be represented by an index value, such as a key value. In some implementations, the record is not actually generated, but is a virtual record of data available in the real-time processing workflow that is associated with the key value of the user.

The detection module 218 is configured to detect whether the virtual record has changed for an entity based on receiving the transaction data 104a-c items. When an item of transaction data 104a-c changes a virtual record for an entity, the detection module generates a notification (subsequently described in greater detail). The notification is output by the real-time segmentation invoker 212. The notification invokes the segmentation engine 120 to generate a real-time segment for the user based on the virtual record generated by the record generator module 216.

The segmentation engine 120 is configured to generate real-time segments 222a-c based on the virtual record and notification associated with the key value of the user received from the real-time segmentation invoker 212. The segmentation engine 120 applies segmentation rules 122 to the virtual record for the user's key when invoked by the notification specifying the key value. The segmentation engine 120 generates a real-time segment 222a-c for the user, as described previously. The segmentation engine 120 outputs the real-time segments 222a-c to a downstream system configured to use the real-time segments, such as the transaction processing system 230 (as previously described).

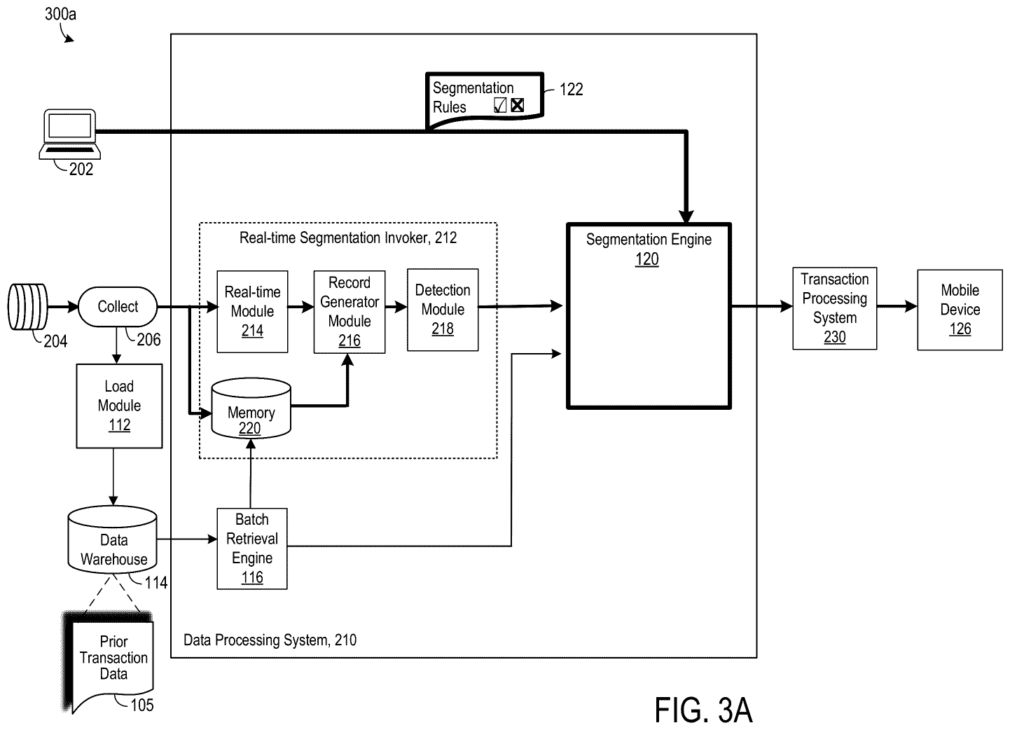

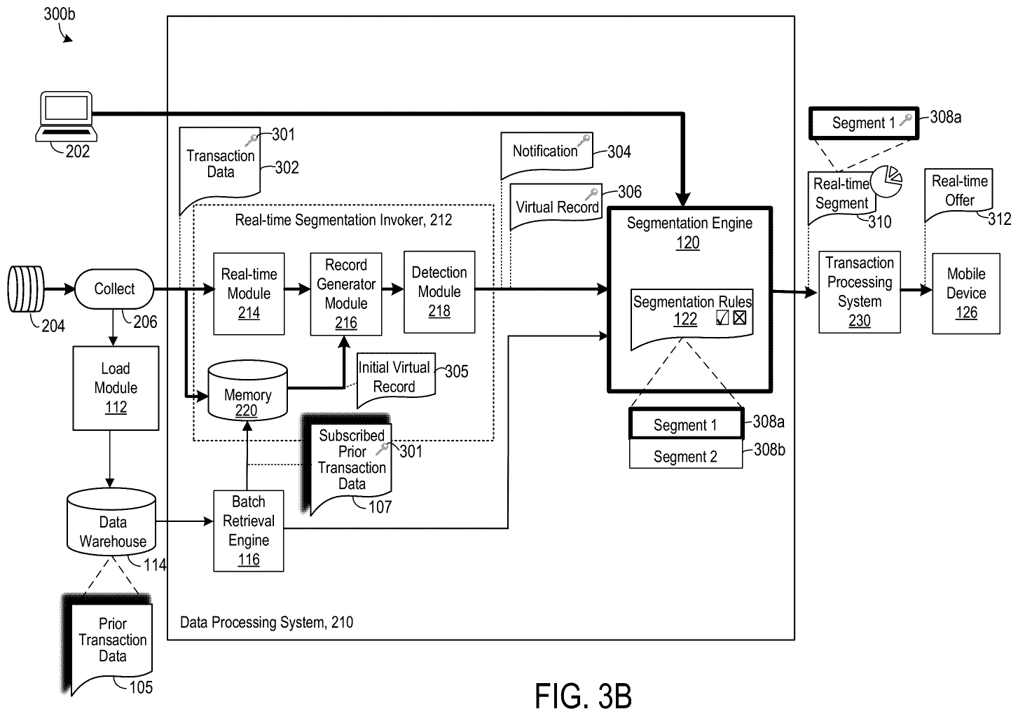

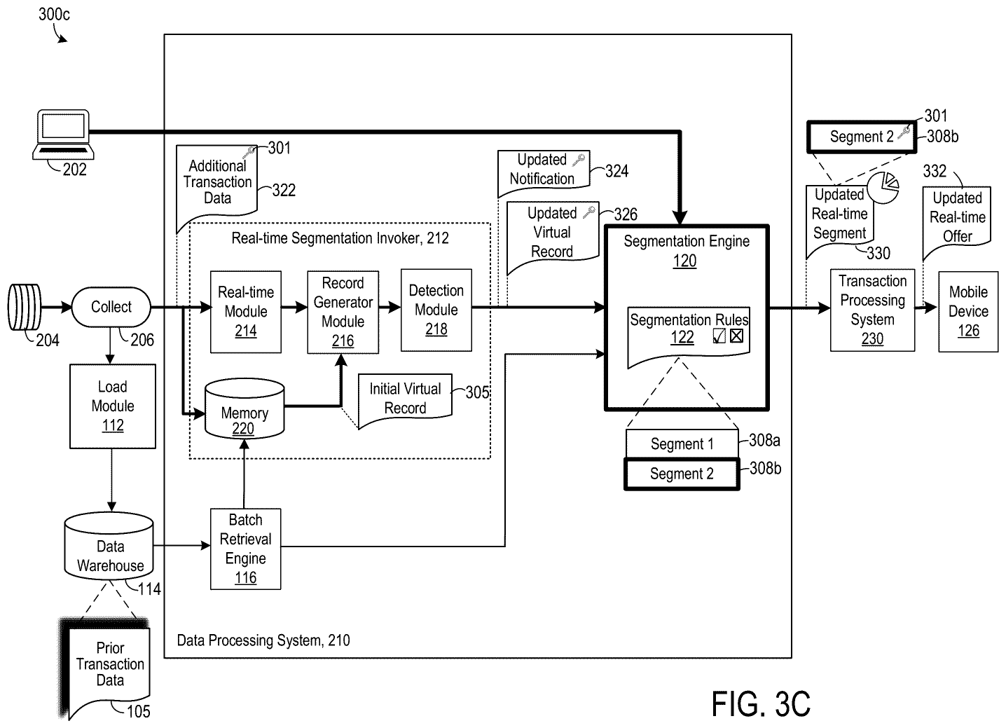

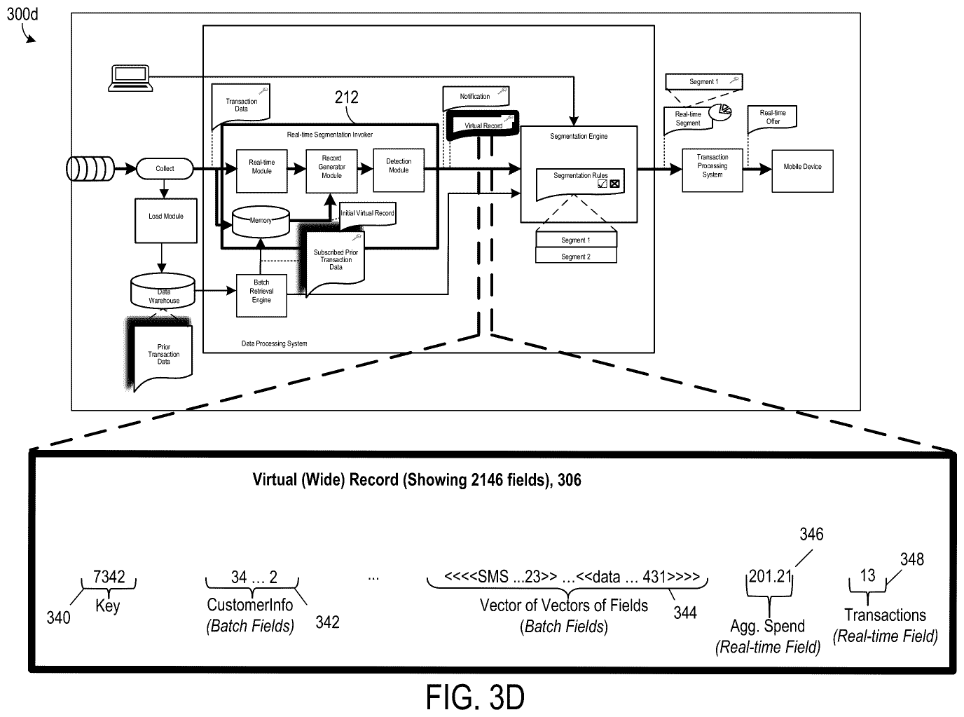

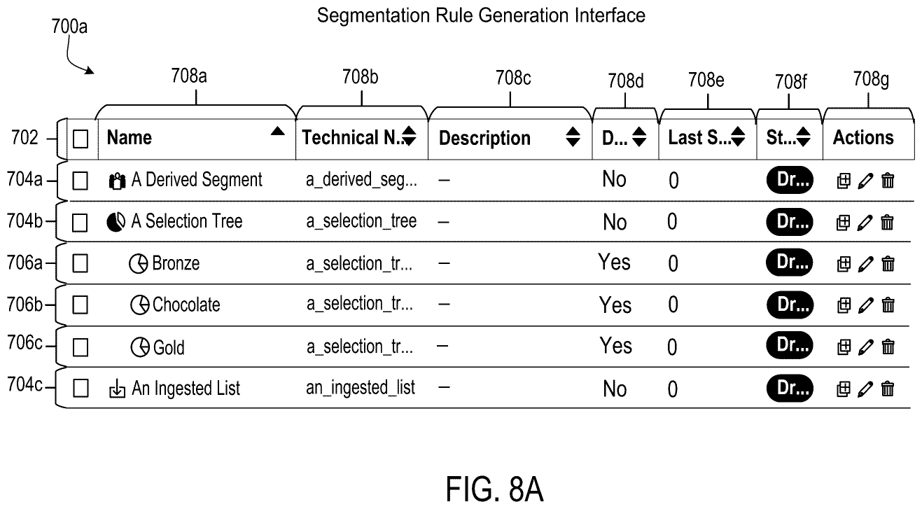

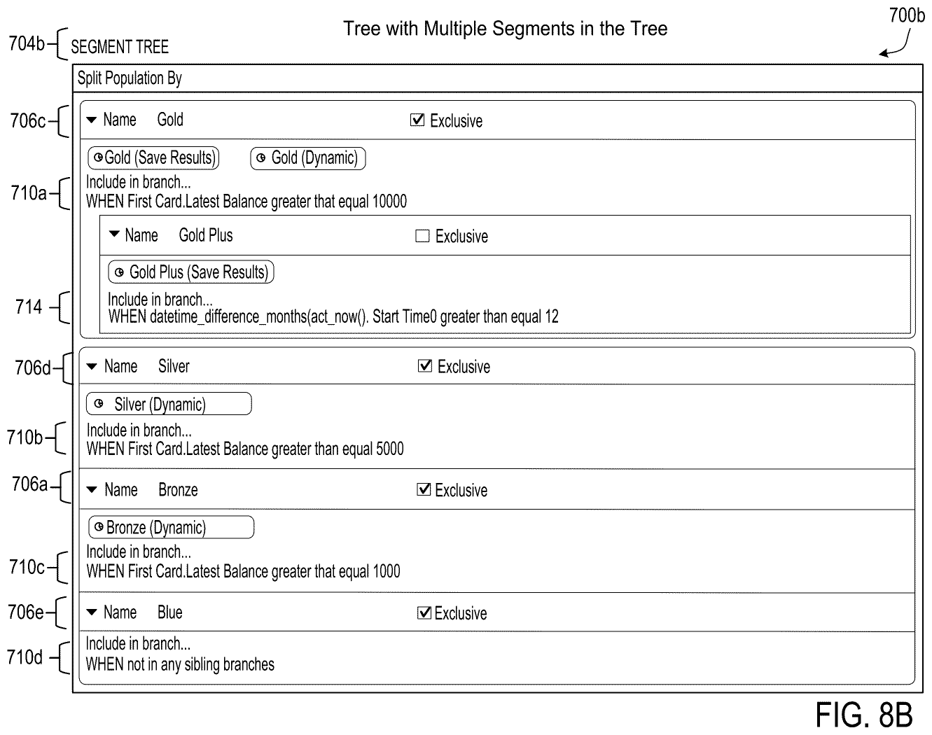

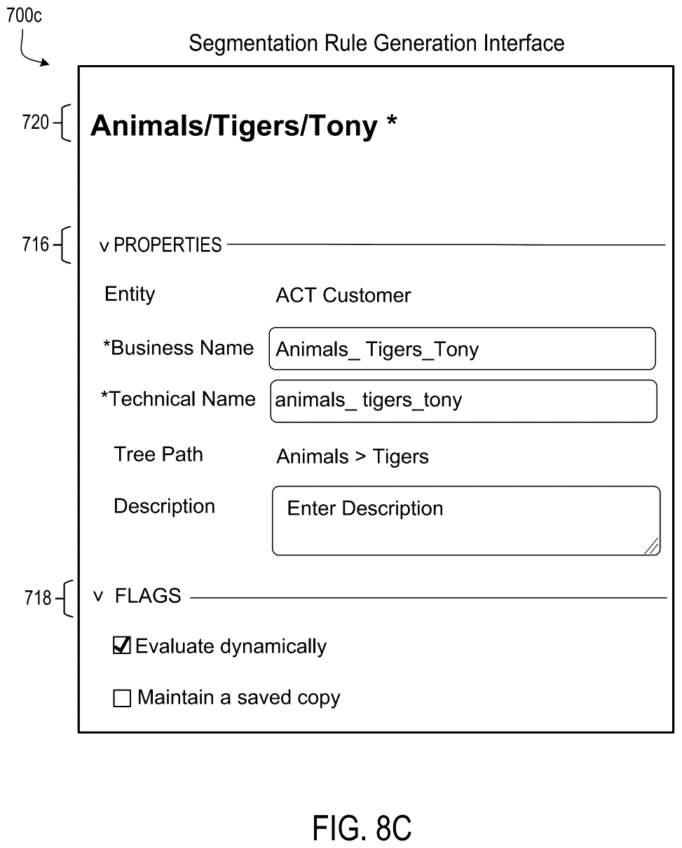

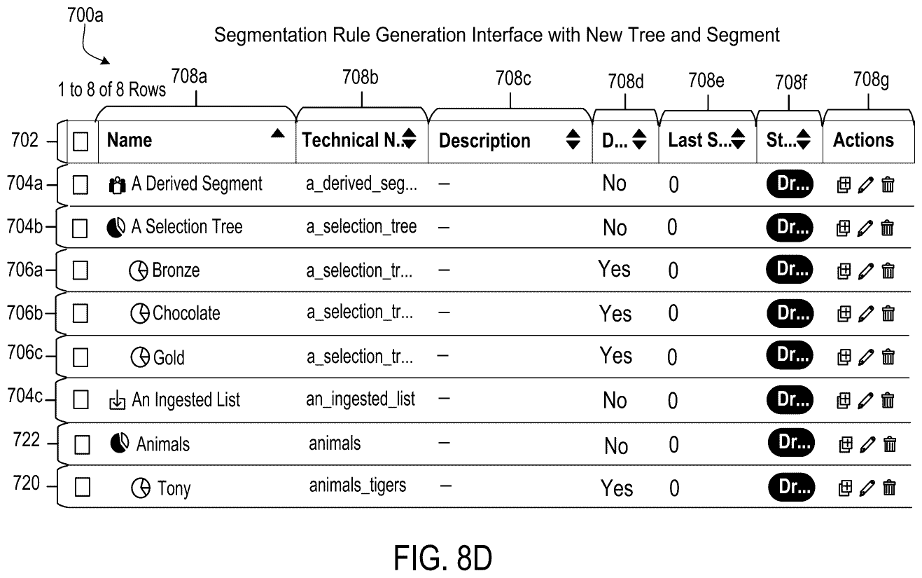

FIGS. 3A-3C are diagrams of the system 200 of FIG. 2 in stages of just-in-time segmentation definition. In FIG. 3A, the data processing system 210 is at an initial stage 300a for just-in-time segmentation definition. At stage 300a, the data processing system 210 is configured to receive segmentation rules 122 from a client device 202. The segmentation rules 122 include definitions of each segment for users. For example, the segmentation rules 122 specify, for various attributes of users, which values are required for an entity to be in a given segment. The segmentation rules can include as many segments as desired. The segmentation rules 122 include logic that determines which segment is associated with users. The logic specifies a priority order for applying rules of segmentation rules. A user interface of the client device 202 is provided to enable an entity to define the segments as desired. The user interface(s) are described in relation to FIGS. 8A-8D.

The segmentation rules 122 include rules for associating a key value (of an entity) with each segment defined in the segmentation rules. The rules can represent conditions that are satisfied to assign a segment to the key value. The rules can be executed in an ordered sequence to apply the logic of the rules to the record generated by the record generator module. If each criterion is satisfied by the data of the record, the user is in each segment defined by those criteria, and the key value of the user is associated with the segment.

The data processing system 210 can associate one or more real-time segments with a key value of an entity. The key value is not restricted to a single real-time segment if the real-time segments are defined to permit an entity to be in multiple segments concurrently. The segmentation engine 120 identifies all segments that are eligible for the record of the key value. Each real-time segment is sent (with the key value) to the transaction processing system 230 when the real-time segment data for a key value is needed by the transaction processing system 230.

FIG. 3B shows a state 300b of the data processing system 210 for generating a virtual record 306 for an entity based on the key value of the user. The virtual record 306 is a wide record that includes both real-time data (e.g., transaction data 302) from the real-time data source 204 and batch data (e.g., prior transaction data 107) from the data warehouse 114. The virtual record 306 can also include other data associated where the key value 301 that is associated with the particular transaction data 302 being processed by the data processing system 210. The virtual record 306 combines both the batch data and real-time data into a common record such that the segmentation engine 120 can determine a real-time segment associated with the key value 301 in real-time or near real-time as the transaction data are processed in the workflow.

Referring now to FIG. 3D, a reduced version of FIG. 3B is shown with the real-time segmentation invoker 212 highlighted. Refer to FIG. 3B, if needed, to identify where the real-time segmentation invoker 212 is placed in relation to other elements of FIG. 3B. Also shown in FIG. 3D is a wide record 306 that is generated by the real-time segmentation invoker 212. Wide record 306 includes numerous fields, including, e.g., fields 340, 342, 344, 346 . . . 348. Some of the fields 340, 342, . . . 348 can be a vector of fields and/or a vector of a vector. In an example, a wide record includes a data structure that is structured with fields, with each field storing or being associated with a data value.

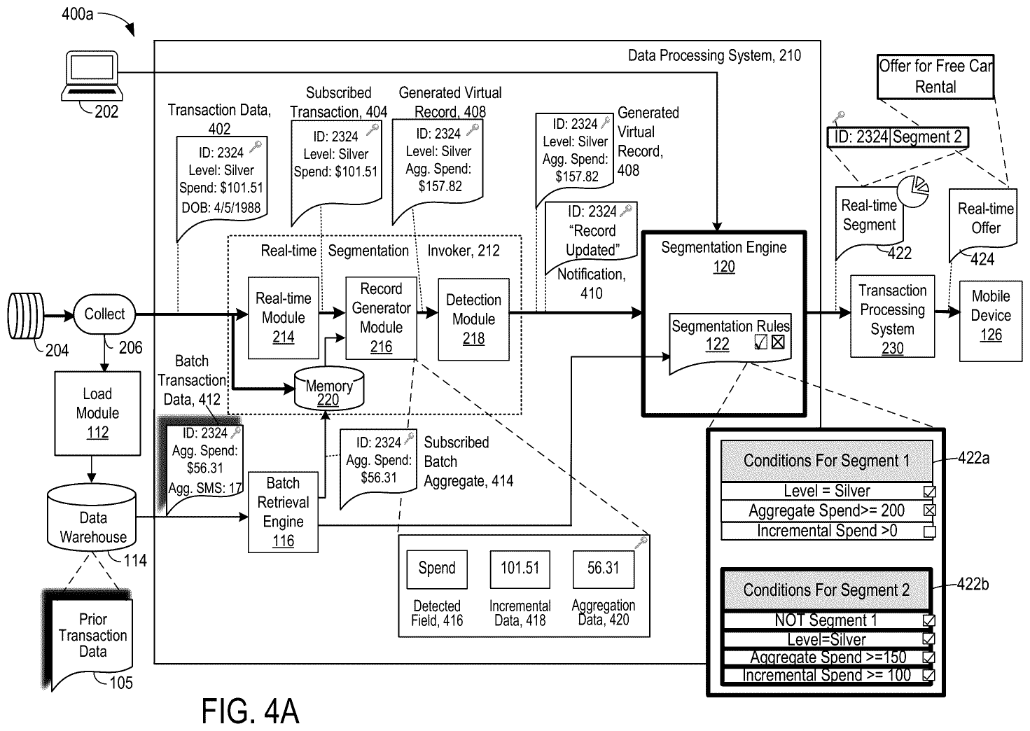

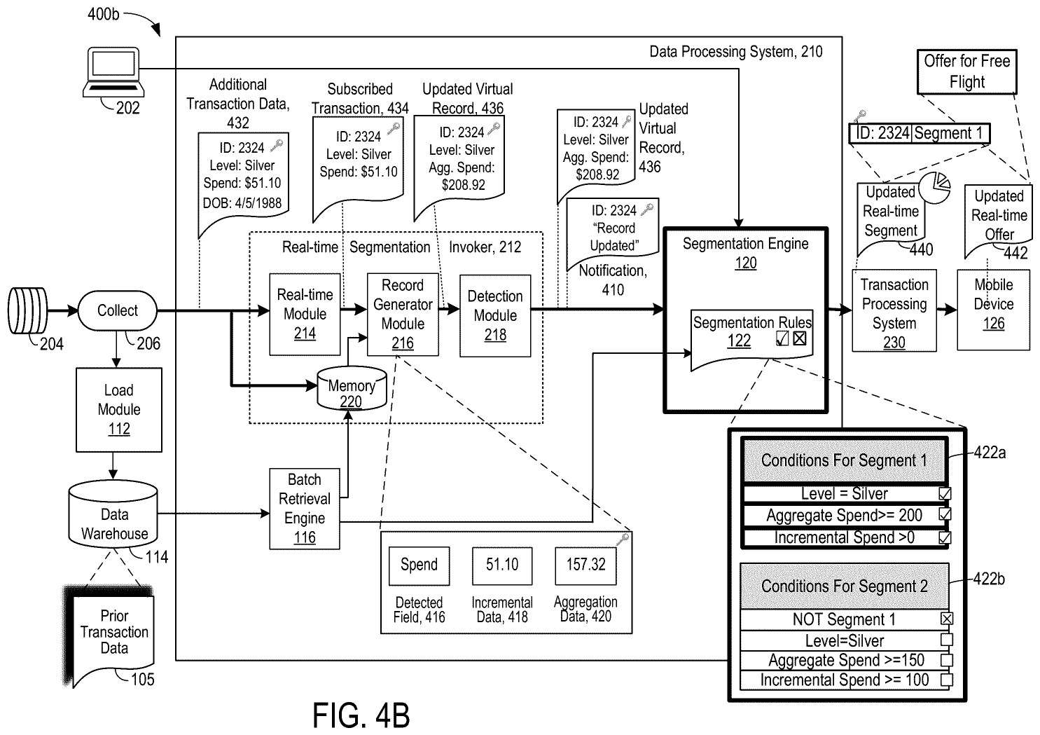

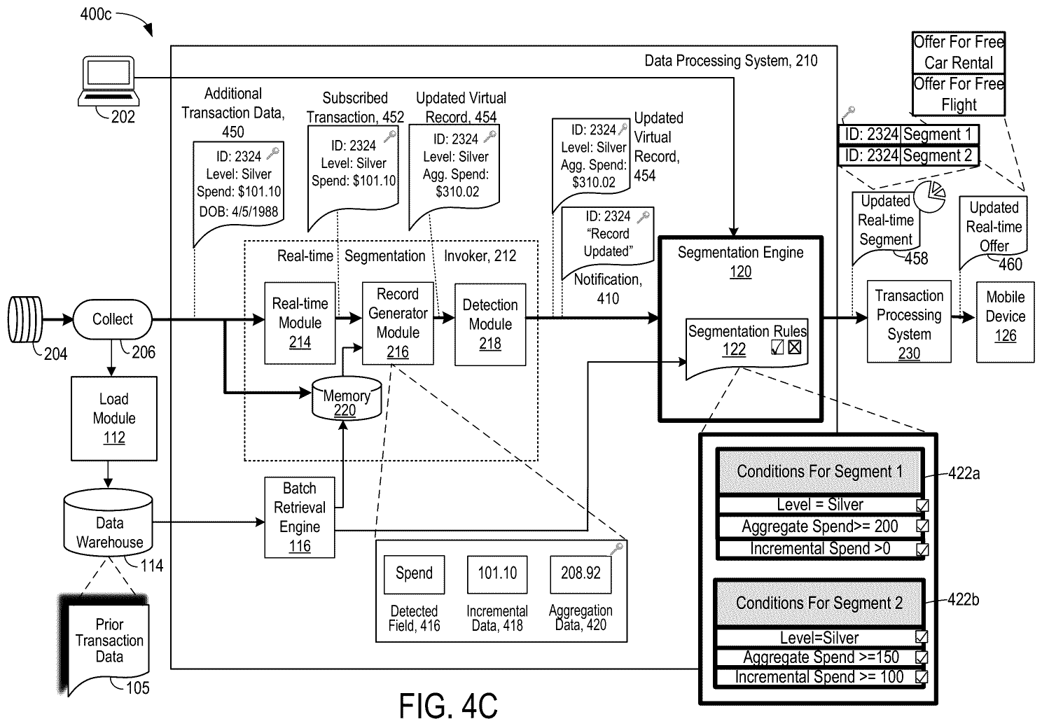

The wide record 306 shows 2146 fields comprising a field 340 storing a key (e.g., key 301) represented by 4 characters, customer information (batch fields) 342 represented by a large plurality of fields, a vector of vectors fields (batch fields) 344 represented by a large plurality of fields, an aggregate spend (a real-time field) 346, and transaction fields (real-time fields) 348. The real-time segmentation invoker 212 produces a wide record 306 as:
7342; 34 . . . 2, . . . , . . . [431]; 201.21, 13,
Key; Batch fields; Real-time fields
   where the wide record 306 includes in the batch field for key 7342 the age “34,” the SMS data 431 for message 23, the aggregate spend 201.21, and number of transactions being 13. The segmentation engine 120, subsequently described in further detail, is configured to execute logic of segmentation rules 122 that specifies a particular segment associated with key value 7342 based on one or more of the values of fields 342, 344, 346, and 348. Examples of the segmentation rules 120 are subsequently described in relation to FIGS. 3D, 3C, 4A, 4B, and 4C. Based on the execution of the logic of the segmentation rules, the data processing system 202 is configured to determine a real-time segment associated with the key 7342. a transaction processing system 230, subsequently described, can determine whether an entity (e.g., subscriber, customer, company, enterprise, and so forth) associated with key value 7342 qualifies for a real-time offer based on a real-time segment determined by the segmentation engine 120. The transaction processing system 230 generates a real-time offer 312 that is sent to and received by a device, such as a mobile device 126.

As previously described, part of the information in the wide record includes batch data and part of the information includes real-time information. To start the process of receiving the wide record, the segmentation engine 120 can send a request for the virtual record 306 to the real-time segmentation invoker 212. In an example, the real-time segmentation invoker 212 sends the virtual record 306 to the segmentation engine 120 responsive to an update of the virtual record and without a request from the segmentation engine. The real-time segmentation invoker 212 sends a notification 304 along with the updated virtual record 306 as subsequently described. Each of the notification 304 and the virtual record 306 are associated with the key value of the key 301. The segmentation engine 120 is triggered to execute segmentation rules 122 responsive to receiving the notion 304 and the virtual record 306 within a threshold time period, such as in real-time

The wide record 306 includes the batch fields 342 . . . 344, which are out of date four generation of the real-time segment, as previously discussed. Wide record 306 also includes the real-time fields 346 . . . 348 which are current and are up to date in real-time, relative to when transaction data 302 are generated. This example illustrates that by pre-specifying which fields 346 . . . 348 are real-time fields and which fields 342 . . . 344 are batch fields, data processing system 210 conserves system resources (e.g., processing resources and memory resources) by not having to continuously generate up-to-date data records and also by not having to retrieve—in real-time—values for all fields from persistent memory, which may introduce latency that precludes generation of the real-time segment in real-time with respect to the generation of the transaction data 302. Rather, at the time of generation of the transaction data 302, the data processing system 210 only retrieves values for a subset of fields that will be used by the segmentation engine 120 for execution of the logic of the segmentation rules 122. Those subset of fields are the real-time fields 346 . . . 348.

This technique is very effective when a real-time data record is not frequently required, but when a real-time data record is needed—it is important that some fields be up to date in real-time relative to when the request is received. As such, these techniques provide for increased computational efficiency for computing real-time records, responsive to a request, because the records do not need to be continuously updated—rather they are only updated when needed.

Additionally, the system described herein generates wide records 306—responsive to detection of new transaction data 302 available at the real-time data source 204—when a certain amount of latency (˜1 ms) is acceptable in providing the record. In other examples, no latency is acceptable in producing a record 306. In these examples where no latency is acceptable, the wide record is updated constantly—even when the record 306 is not being used and the trade-off (for constantly updating the records) is increased consumption of processing power and memory resources. However, when this certain amount of latency is acceptable, the system described herein takes advantage of being able to generate the wide record 306—with the real-time data retrieved from the real-time data source 204—on demand, which results in improved memory consumption and computational resources (relative to memory consumption and computational resources when a record has to be constantly updated) due to the fact that only information that is actually requested is retrieved from operational systems and used in updating the data records. Additionally, the classification of data fields as being either real-time fields or batch fields—provides for a decreased amount of latency (relative to an amount of latency in retrieving all the data in real-time from operational systems) in generating the record in response to a request. When configuring the system, this classification is done such that data that is of relatively high importance (e.g., to execution of rules) or data that changes frequently is classified as “real-time” and data that changes less frequently or is less important to real-time decisioning (through execution of rules) is classified as batch. Thus, the techniques described herein reduce latency and memory resources in generating these wide records, while increasing computational efficiency in doing so.

Returning to FIG. 3B, the real-time segmentation invoker 212, using the real-time module 214, record generator module 216, and detection module 218, processes the items of transaction data 104a-c and determines if a real-time segment should be generated by the segmentation engine 120. When the invoker 212 determines, for a key value, that a real-time segment should be computed by the segmentation engine 120, the invoker generates a notification 304 to invoke the computation of the real-time segment and sends the associated virtual record 306 to the segmentation engine 120.

To begin processing an item of the transaction data 104a-c, the data processing system 210 determines a key value 301 that is specified or included in the item of transaction data 104a-c. The key value 301 generally indicates an entity, subscriber, computing system, or other entity associated with the item of transaction data 104a-c. The data processing system 210 requests related prior transaction data 105 from the data warehouse 114. The prior transaction data 105 is associated with the same key value 301. The data from the data warehouse can also include any attributes or other metadata describing the user that may be used to determine the user's real-time segment.

Portions of the prior transaction data 105 from the warehouse 114 can be loaded, e.g., by the batch retrieval engine 116, into volatile memory 220 of the data processing system 210 (real-time workflow) prior to receiving items of transaction data 104a-c, such as at the beginning of the working hours of each time period such as one day. The portions of the prior transactions data 105 that are loaded into the memory 220 in the real-time workflow are called subscribed prior transactions data 107. The subscribed prior transactions data 107 are loaded in batch (e.g., when the batch processing workflow updates the prior transaction data 105). The selection fields (or specific transactions) of the subscribed prior transactions data 107 is based the subscription of transactions from the real-time data source 204 for the real-time segmentation invoker. The subscription specifies for which transactions a real-time segment may be generated. The subscription is defined based on which real-time segments are defined in the segmentation rules 122 and based on user input (e.g., in advance of processing data in the real-time workflow of the data processing system 210). The availability of the transaction data 105 in volatile memory 220 can reduce a latency of determining the real-time segment of an entity. These data 107 can be stored in memory 220 and updated each time the batch process is executed.

The subscribed prior transaction data 107 includes specific data that are selected based on which real-time segments are defined in the segmentation rules 122. For example, different real-time segments may use different fields of the prior transaction data 105. When the batch retrieval engine 116 generates the subscribed batch aggregate for storing in the memory 220 in the real-time segmentation invoker, the prior transaction data 105 include any batch data that are needed for generating the real-time segments 310 from the transaction data 302 in real-time. The specific data in the prior transactions data 105 can be different for each period of time (e.g., each day) between updates to the prior transaction data 105 in the data warehouse 112. For example, a user, through interface of device 202, may define different real-time segments for a given time period and specify a set of transactions for subscription for which real-time segments are determined.

The real-time module 214 receives the items of transaction data 104a-c. The real-time module 214 extracts data from the items of transaction data 104a-c that are relevant to processing the transaction data 104 for real-time segment determination. Other data from the real-time stream of data, such as headers, addressing information, and so forth can be removed by the real-time module 214.

The record generator module 216 receives an item of transaction data 104a-c and combines its real-time transaction data with prior transaction data 105 accessed from volatile memory 220. By contrast to the prior art of FIG. 1, no batch retrieval from warehouse 114 is needed when or after the items of transaction data 104a-c are received within the current time period (e.g., one day), which items can thus be processed more quickly, such as in real-time, while still having all relevant transaction data available for an accurate and real-time segmentation process. The record generator module 216 generates a comprehensive record for the key value, which can be called a virtual record. The virtual record 306 includes any data that is used for determining the real-time segment of the user associated with the key value. The virtual record 306 does not need to actually be generated as a data item. Rather, the virtual record 306 enables the segmentation engine 120 to access any data needed for the given key associated with the transaction data 104a-c.

The detection module 218 determines, for a given key, whether the record 306 represents a change to any of the relevant fields that may affect a real-time segment of the user. The detection module 218 detects when data in a relevant field are changed. If this occurs, the detection module 218 generates a notification 304 that invokes the segmentation engine 120 to determine the real-time segment(s) for the key value. The generation of the notification 304 enables the segmentation engine 120 to generate real-time segment(s) only when the transaction data 104a-c is potentially causing a change to a real-time segment for the key value. The segmentation engine 120 does not need to calculate updated real-time segment(s) for the key value for each item of transaction data 104a-c that is received. This saves computing bandwidth. However, if further real-time transaction data is received in a further item of transaction data 104a-c, this data can be combined with previously received real-time transaction data of another received item of transaction data 104a-c, because this transaction data is still available from the real-time data source 204-206 and is combined with the prior transaction data 105 accessed from memory 220.

The segmentation engine 120 uses the segmentation rules 122 that are defined at the client device 202 to determine the real-time segment(s) for the key value. The segmentation engine 120 computes the real-time segment(s) for a key value by processing the record 306 associated with the key value when a notification 304 is provided that invokes the segmentation engine 120 to proceed.

The segmentation engine 120 applies the segmentation rules 122 by applying the conditions specified in the segmentation rules. The segmentation engine 122 identifies one or more segments 308a-b that satisfy the segmentation rules for the key value.

The segmentation engine 120 outputs real-time segment(s) 310 for the key value 301 representing the user. The real-time segment 310 can include any one of the available segments 308a-b when those segments satisfy the segmentation rules 122.

The transaction processing system 230 receives the real-time segments 310 and determines one or more actions that can be performed for a remote computing device associated with the user that is represented by the key value. The transaction processing system 230 generates instructions for execution of the action. For example, the action can include presentation of an offer 312 (e.g., a discount, voucher, upgrade, etc.) to an entity based on the new real-time segment 310 in which the user is categorized. The data including the offer 312 are sent to a remote computing device (e.g., mobile device 126) for execution of the instructions specified in the offer data 312.

FIG. 3C shows a state 300c representing processing of additional transaction data 322 to update a real-time segment 330 associated with the key value 301. The process in FIG. 3C is similar to the process of FIG. 3B. The additional transaction data 322 is associated with the same key value 301 as transaction data 104a-c. The real-time segmentation invoker processes the transaction data 322 and generates an updated virtual record 326 including the updated transaction data 322. The invoker 212 determines that the updated virtual record 326 can potentially change a real-time segment for the key value 301. The invoker therefore generates an updated notification 324 indicating to the segmentation engine 120 that an updated segment should be calculated for the key value 301. The additional transaction data 322 can be transaction data received the same day or subsequent to the item of transaction data 104a-c.

The segmentation engine 120 processes the updated record 326. The segmentation engine determines that the updated record 326 does not satisfy a first segment 308a (as record 306 did) but rather a second segment 308b. The segmentation engine 120 generates data representing the updated real-time segment 330 for the key value 301. The updated real-time segment is sent by the data processing system 210 to the transaction processing system 230, which generates instructions for presentation of an updated real-time offer 332. These instructions are sent to the mobile device 126 for execution and presentation of the offer.

FIGS. 4A-4C are diagrams of the system of FIG. 2 in stages of just-in-time segmentation in which real-time segments are generated. At stage 400a of FIG. 4A, the data processing system 210 receives transaction data 402. The transaction data 402 includes a key value ID=2324. There are other data included in the transaction data 402 such as a current segment “Level=Silver.” Attribute data are included in the transaction data 402, such as a spend total=$101.51 and a date of birth “DOB=4/5/1988.”

The data processing system 210 accesses, from the data warehouse, prior transaction data 105 for the key value ID=2324. These data are the batch transaction data 412. Batch transaction data 412 specifies that the aggregate spend for the key value ID=2324 is $56.31, and that an aggregate number of SMS messages associated with the key value is 17. The batch retrieval engine 116 extracts fields of the data 412 that are related to subscribed transactions. For this example, the data for the SMS aggregate can be discarded and not stored in memory 220. The batch retrieval engine 116 generates a subscribed batch aggregate 414 including the relevant fields for the key value 2324. The batch retrieval engine sends the subscribed batch aggregate 414 to the memory 220.

The fields of the subscribed batch aggregate data 414 are based on which real-time segments are defined in the segmentation rules 122. For example, different real-time segments may use different fields of the batch transaction data. When the batch retrieval engine 116 generates the subscribed batch aggregate for storing in the memory 220 in the real-time segmentation invoker, the subscribed batch aggregate data 414 include any batch data that are needed for generating the real-time segments 422 from the transaction data 402 in real-time.

The real-time module 214 removes data that are not needed for the calculation of a real-time segment. For example, the fields related to a subscribed transaction 404 can be extracted from the transaction data 402. The real-time module 214 generates data 404 that includes the ID, Level, and Spend fields.

The record generator module 216 combines the subscribed transaction data 404 with the subscribed batch aggregate 414 data to generate the record 408. The record 408 can be a virtual record representing all the relevant data for a key value that is needed by the segmentation engine 120 to calculate the real-time segment(s) associated with the key value 2324. The record generator module 216 generates a record, for example, with fields including a detected spend field 416 that includes incremental spend data 418 and aggregated spend data 420. The record generator module 216 combines the data from the transaction 402 with the batch aggregate 414. For example, the incremental spend $101.51 of the transaction data 402 is combined with the aggregate spend 420 of the batch aggregate 414 to generate a total aggregate spend of $157.82.

The detection module 218 determines that a relevant field for a segment is included or changed in the record 408. The change can be detected based on checking a list of relevant fields (including the “Spend” field 416) for real-time segmentation or by comparing the record to a previous record associated with the key value. When the record 408 includes an updated value, the detection module 218 generates a notification 410 specifying that the “record is updated” for the key ID=2324. The notification 410 and the record 408 are sent to the segmentation engine 120.

The segmentation engine applies the segmentation rules 122 to the generated record 408. The segmentation engine 120 can apply the conditions for each segment to the data in the generated record 408. For example, for segment 1 422a, the segmentation engine checks if the level=silver, if the aggregate spend is over 200, and if the incremental spend value is greater than 0 (indicating that the user spent something in the most recent transaction 402). The segmentation engine 122 determines, based on the record 408, that the level=silver condition is satisfied (shown by a check mark). The segmentation engine determines that the condition “aggregate spend >=200” is not satisfied, shown by an “X” mark. The segmentation engine does not need to check the “incremental spend >0” condition because segment 1 does not apply.

The segmentation engine 120 then applies the conditions for segment 2 422b. The segmentation engine 120 determines that the key value ID=2324 is NOT in segment 1, and so the first condition is satisfied. The segmentation engine 120 determines that the second condition “level=silver” is satisfied. The segmentation engine 120 determines that the third condition “aggregate spend >=150” is satisfied because the aggregate spend is now $157.82 of record 408, which combines the incremental spend $101.51 and the aggregate spend $56.31. The segmentation engine determines that the fourth condition “incremental spend >=100” is satisfied because the incremental data 418 from the transaction data 402 is $101.51. Thus, all four conditions are satisfied for segment 2 422b. The key value ID=2324 is associated with real-time segment 2. The real-time segment 422 is sent to the transaction processing system 230 as previously described for generating a real-time offer 424 of “offer for free car rental,” as previously described.

At stage 400b of FIG. 4B, the data processing system 210 receives additional transaction data 432. These additional transaction data 432 are processed by the invoker 212 to determine if an updated real-time segment should be calculated by the segmentation engine 120. The transaction data 432 includes the key value ID=2324, which was included in the transaction data 402 of FIG. 4A. There are other data included in the transaction data 32 such as a current segment “Level=Silver.” Attribute data are included in the updated transaction data 432, such as an incremental spend total=$51.10 and a date of birth “DOB =4/5/1988.”

The data processing system 210 has already stored prior transaction data 105 for the key value ID=2324 in the memory 220. The value for the aggregate spend 420 for field spend 416 is already stored in memory 220. Batch transaction data specifies that the aggregate spend for the key value ID=2324 is $157.31, which includes the batch aggregate spend $56.31 and the incremental spend $101.51 of the transaction data 402.

The real-time module 214 removes data that are not needed for the calculation of a real-time segment, as previously described. For example, the fields related to a subscribed transaction data 432 can be extracted from the transaction data 432. The real-time module 214 generates subscribed transaction data 434 that includes the ID, Level, and Spend fields.

The record generator module 216 combines the subscribed transaction data 434 with the subscribed batch aggregate data to generate the updated record 436 than incorporates incremental spend data from the additional transaction data 432. The record generator module 216 combines the data from the transaction data 434 with the batch aggregate 414. For example, the incremental spend $101.51 of the transaction data 402 and the incremental spend $51.10 of the additional transaction data 432 are combined with the aggregate spend 420 of the batch aggregate 414 to generate a total aggregate spend of $208.92.

The detection module 218 determines that a relevant field for a segment is included or changed in the record 436. The change can be detected based on checking a list of relevant fields (including the “Spend” field 416) for real-time segmentation or by comparing the record to a previous record associated with the key value. When the record 436 includes an updated value for the Spend field 416, the detection module 218 generates a notification 410 specifying that the “record is updated” for the key ID=2324. The notification 410 and the updated record 436 are sent to the segmentation engine 120.

The segmentation engine applies the segmentation rules 122 to the updated record 436. The segmentation engine 120 can apply the conditions for each segment to the data in the updated record 436. For example, for segment 1 422a, the segmentation engine checks if the level=silver, if the aggregate spend is over 200, and if the incremental spend value is greater than 0 (indicating that the user spent something in the most recent transaction 402). The segmentation engine 122 determines, based on the record 436, that the level=silver condition is satisfied (shown by a check mark). The segmentation engine determines that the condition “aggregate spend >=200” is satisfied. The segmentation engine determines that the “incremental spend >0” condition is satisfied. Therefore segment 1 applies to the key value ID=2324. This updated real-time segment 440 is sent to the transaction processing system 230, as previously described. The transaction processing system generates an updated real-time offer 442 based on segment 1 being applicable. The offer specifies a “free flight.”

The segmentation engine 120 then applies the conditions for segment 2 422b. The segmentation engine 120 determines that the key value ID=2324 is in segment 1, and therefore the first condition is not satisfied, as shown by the “X” mark. The check for segment 2 is completed.

At stage 400c of FIG. 4C, the data processing system 210 receives additional transaction data 450. These additional transaction data 450 are processed by the invoker 212 to determine if an updated real-time segment should be calculated by the segmentation engine 120. The transaction data 450 includes the key value ID=2324, which was included in the transaction data 402 of FIG. 4A. There are other data included in the transaction data 450 such as a current segment “Level=Silver.” Attribute data are included in the updated transaction data 450, such as an incremental spend total=$101.10 and a date of birth “DOB=4/5/1988.”

The data processing system 210 has already stored prior transaction data 105 for the key value ID=2324 in the memory 220. The value for the aggregate spend 420 for field spend 416 is already stored in memory 220. Batch transaction data 412 specifies that the aggregate spend for the key value ID=2324 is $208.92, as previously described.

The real-time module 214 removes data that are not needed for the calculation of a real-time segment, as previously described. For example, the fields related to a subscribed transaction data 540 can be extracted from the transaction data 450. The real-time module 214 generates subscribed transaction data 452 that includes the ID, Level, and Spend fields.

The record generator module 216 combines the subscribed transaction data 452 with the subscribed batch aggregate 414 data to generate the updated record 454 that incorporates incremental spend data from the additional transaction data 450. The record generator module 216 combines the data from the transaction data 450 with the batch aggregate 414. For example, the incremental spend $101.51 of the transaction data 402, the incremental spend of the additional transaction data $51.10, and the incremental spend of the additional transaction data 450 are combined with the aggregate spend $157.41 of the batch aggregate 414 to generate a total aggregate spend of $310.02.

The detection module 218 determines that a relevant field for a segment is included or changed in the record 454. The change can be detected based on checking a list of relevant fields (including the “Spend” field 416) for real-time segmentation or by comparing the record to a previous record associated with the key value. When the record 454 includes an updated value for the Spend field 416, the detection module 218 generates a notification 410 specifying that the “record is updated” for the key ID=2324. The notification 410 and the updated record 454 are sent to the segmentation engine 120.

The segmentation engine applies the segmentation rules 122 to the updated record 454. The segmentation engine 120 can apply the conditions for each segment to the data in the updated record 454. For example, for segment 1 422a, the segmentation engine checks if the level=silver, if the aggregate spend is over 200, and if the incremental spend value is greater than 0 (indicating that the user spent something in the most recent transaction 402). The segmentation engine 122 determines, based on the record 454, that the level=silver condition is satisfied (shown by a check mark). The segmentation engine determines that the condition “aggregate spend >=200” is satisfied. The segmentation engine determines that the “incremental spend >0” condition is satisfied. Therefore segment 1 applies to the key value ID=2324. This updated real-time segment 458 is sent to the transaction processing system 230, as previously described. The transaction processing system generates an updated real-time offer 460 based on segment 1 being applicable. The offer specifies a “free flight.”

The segmentation engine 120 then applies the conditions for segment 2 422b. The segmentation engine 120 determines that the first condition “level=silver” is satisfied. The segmentation engine 120 determines that the second condition “aggregate spend >=150” is satisfied because the aggregate spend is now $310.02 from record 454. The segmentation engine determines that the third condition “incremental spend >=100” is satisfied because the incremental data 418 from the transaction data 450 is $101.10. Thus, all three conditions are satisfied for segment 2 422b. The key value ID=2324 is associated with real-time segment 2. The real-time segment 458 is sent to the transaction processing system 230 as previously described for generating a real-time offer 460 of “offer for free car rental,” as previously described. In this example, both segment 1 and segment 2 of real-time segments 422 are included in the real-time segment 458. The offer includes offers for members of each of segment 1 and segment 2.

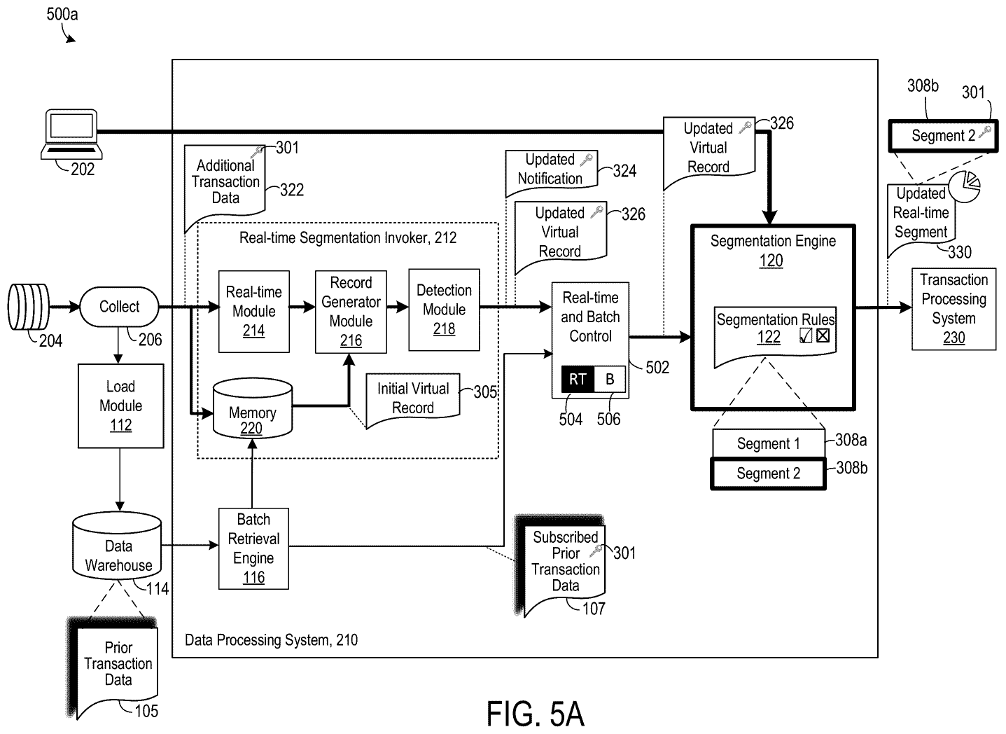

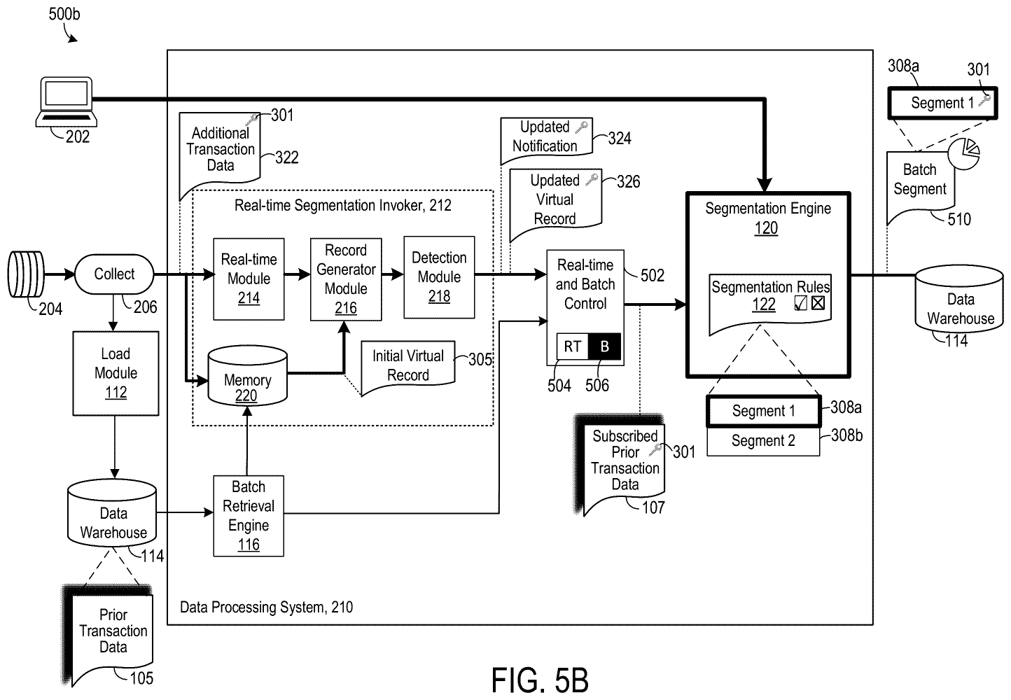

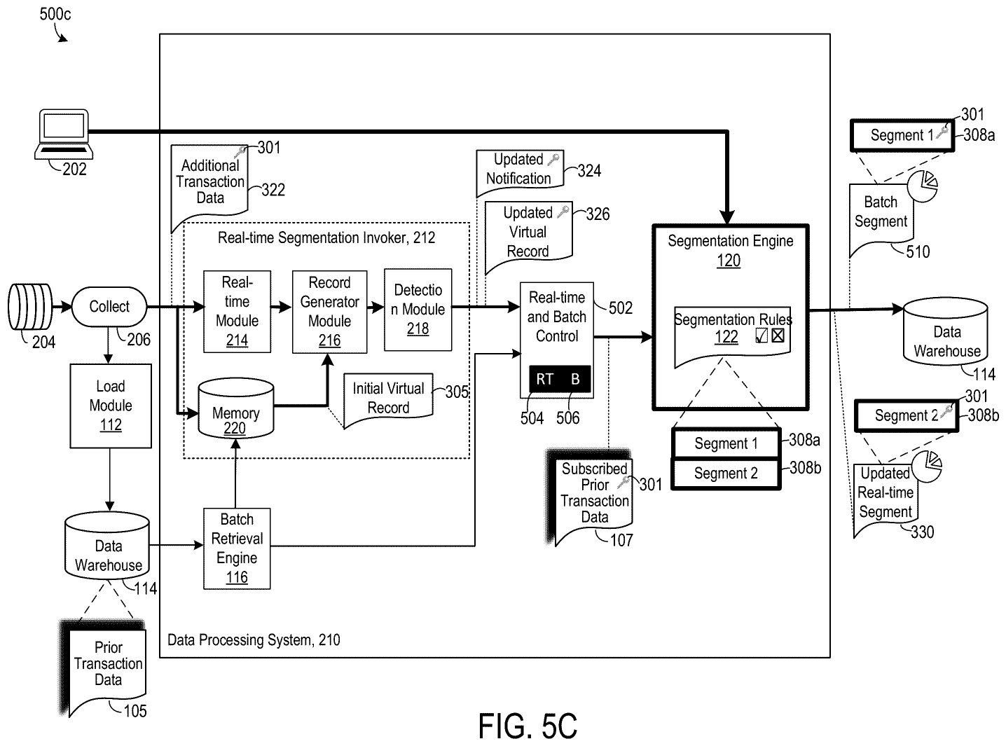

FIGS. 5A-5C are diagrams of the system 200 of FIG. 2 in stages of just-in-time segmentation definition. In FIG. 5A, system 500a is shown including data processing system 210, which is described previously in relation to FIG. 3A. The data processing system 210 includes a real-time and batch control 502, also called a control 502 or a RT/B control 502. The control 502 has a real-time switch 504 and a batch switch 506. When the real-time (RT) switch 504 is selected, the control allows real-time data (including real-time transaction data) to the segmentation engine for generating an updated real-time segment 330. When the batch switch 506 is selected, the control allows batch data including prior transaction data from the data warehouse to the segmentation engine for generating a batch segment. The control enables the segmentation engine 120 to generate both real-time segments and batch segments for an entity using the same segmentation rules 120. For example, through a user interface, a user can toggle the control 502 to cause the segmentation engine to generate a real-time segment 330 with a left click or a batch segment 510 with a right click.

In FIG. 5B, system 500b is shown including data processing system 210, which is described previously in relation to FIG. 3A. The data processing system 210 includes a real-time and batch control 502, also called a control 502 or a RT/B control 502. The control 502 has a real-time switch 504 and a batch switch 506. In this case, the batch switch 506 is selected. The control allows batch data including prior transaction data from the data warehouse to the segmentation engine for generating a batch segment 510.

In FIG. 5C, system 500c is shown including data processing system 210, which is described previously in relation to FIG. 3A. In this case, the real-time switch 504 and the batch switch 506 are selected. The control enables the segmentation engine 120 to generate both real-time segments and batch segments for an entity using the same segmentation rules 120. The segmentation engine 120 can generate both a real-time segment 330 and a batch segment using the same segmentation rules 120 at the same time.

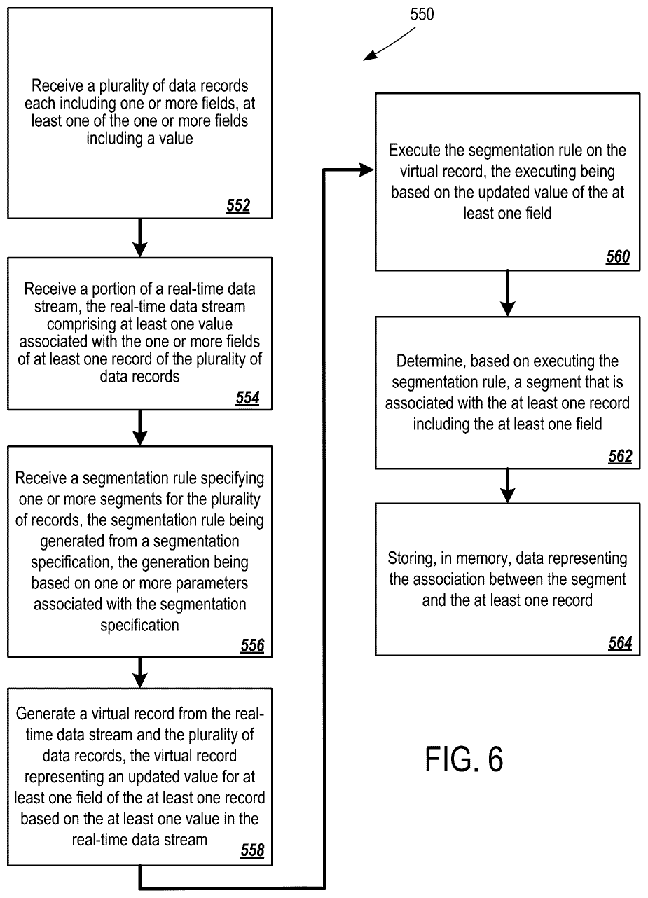

FIG. 6 is a flow diagram depicting a process 550 for just-in-time segmentation in which real-time segments are generated. The process 550 includes receiving (552) a plurality of data records each including one or more fields, at least one of the one or more fields including a value. The process 550 includes receiving (554) a portion of a real-time data stream, the real-time data stream comprising at least one value associated with the one or more fields of at least one record of the plurality of data records. The process 550 includes receiving (556) a segmentation rule specifying one or more segments for the plurality of records, the segmentation rule being generated from a segmentation specification, the generation being based on one or more parameters associated with the segmentation specification. The process 550 includes generating (558) a virtual record from the real-time data stream and the plurality of data records, the virtual record representing an updated value for at least one field of the at least one record based on the at least one value in the real-time data stream. The process 550 includes executing (560) the segmentation rule on the virtual record, the executing being based on the updated value of the at least one field. The process 550 includes determining (562), based on executing the segmentation rule, a segment that is associated with the at least one record including the at least one field. The process 550 includes storing (564), in memory, data representing the association between the segment and the at least one record.

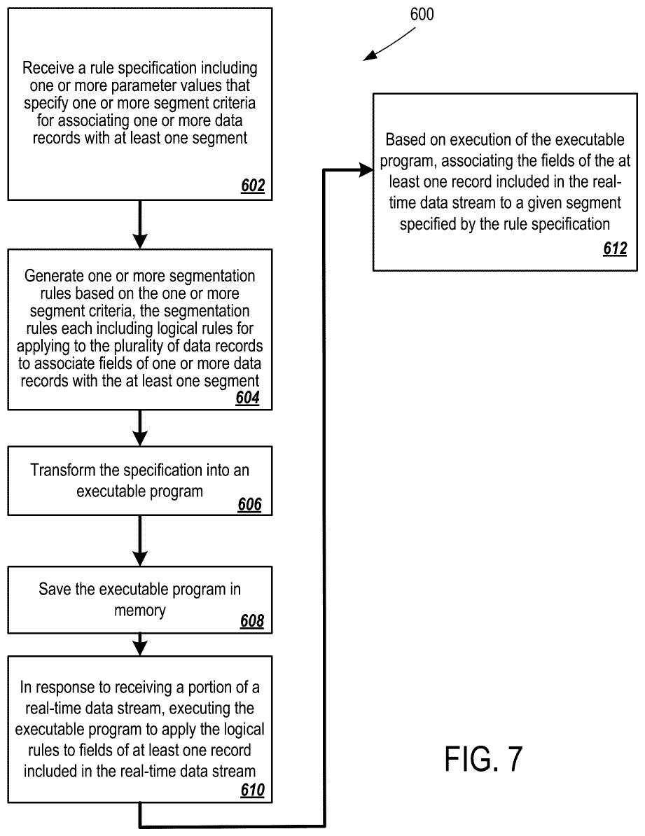

FIG. 7 is a flow diagram depicting a process 600 for just-in-time segmentation in which real-time segments are generated. The process 600 includes receiving (602) a rule specification including one or more parameter values that specify one or more segment criteria for associating one or more data records with at least one segment. The process 600 includes generating (604) one or more segmentation rules based on the one or more segment criteria, the segmentation rules each including logical rules for applying to the plurality of data records to associate fields of one or more data records with the at least one segment. The process 600 includes transforming (606) the specification into an executable program. The process 600 includes saving (608) the executable program in memory. The process 600 includes, in response to receiving a portion of a real-time data stream, executing (610) the executable program to apply the logical rules to fields of at least one record included in the real-time data stream. The process 600 includes, based on execution of the executable program, associating (612) the fields of the at least one record included in the real-time data stream to a given segment specified by the rule specification.

FIGS. 8A-8D are diagrams depicting user interfaces for defining real-time segments including the conditions for the segments. The user interfaces can be used to configure the segmentation rules 122 previously described.

FIG. 8A depicts user interface 700a in which segments 704a-c are shown. An entity can define segments 704a-c (collectively real-time segments 704) by using selection trees. The selection trees include nested logic in which sub-segments, like sub-segments 706a-c, are nested in larger segments, such as real-time segment 704b. The segments 704 include a selection tree with three categories including Bronze, Chocolate, and Gold. The segments 704 include a derived segment 704a, a selection tree segment 704b, and an ingested list 704c. Each of 704a, 704b, and 704c is a different kind of segment definition.

Row 702 includes a header row for each column 708a-gas-enriched liquid describing the segments 704. A first column 708a shows a business name for each segment or sub-segment. Column 708b shows a technical name for each for each segment or sub-segment. Column 708c includes a description for each segment or sub-segment. Column 708d includes an indicator of whether the segment is defined. Column 708e indicates when the segment was last evaluated. Column 708f indicates a status of the segment. Column 708g provides options for editing, removing, or adding sub-segments to a segment.

FIG. 8B depicts user interface 700b in which segment tree 704b is defined by an entity. An entity can define segment 704b by indicating logical conditions for the segment, or in this case, each sub-segment 706a-c. The sub-segments include sub-segment Gold 706c, sub-segment Silver 706d, sub-segment Bronze 706a, and sub-segment Blue 706e. Each of the sub-segments 706a-e includes condition logic 710a-d. Sub-segment 706c Gold also includes a second level sub-segment 712, which is a sub-segment of a sub-segment 706c. The second level sub-segment 712 includes conditional logic 714, defining inclusion in the second level sub-segment.

FIG. 8C depicts user interface 700c in which a new segment 720 is defined by an entity. The segment 720 includes three tiers: Animals, Tigers, and Tony. These are nested so that Tony is a second level sub-segment of Animals. The second level sub-segment 720 can be defined by its properties 716 including its technical name, business name, and its tree path (if a sub-segment). A description can also be provided by the user. The segment 720 can be evaluated dynamically and saved if needed according to logic flags 718.

The segment 722 Tony defined in the interface 700c is shown in the interface 700d of FIG. 7D. The interface 700d is the same as interface 700a, except that new segment tree Animals 722 is shown with sub-segment Tony 720.

Generally, an “entity” includes a portion of a computer program (e.g., a pre-defined portion of a computer program for inclusion in another computer program) or one or more dataflow graph components (e.g., that are encapsulated together into a pre-defined module). Throughout this document, an “entity” may also be referred to as a “module,” without limitation and for purposes of convenience.

Dataflow graph components include data processing components and/or datasets. A dataflow graph can be represented by a directed graph that includes nodes or vertices, representing the dataflow graph components, connected by directed links or data flow connections, representing flows of work elements (i.e., data) between the dataflow graph components. The data processing components include code for processing data from at least one data input, e.g., a data source and providing data to at least one data output, e.g., a data sink of the system 200. The dataflow graph can thus implement a graph-based computation performed on data flowing from one or more input data sets through the graph components to one or more output data sets.

System 200 also includes the data processing system 210 for executing one or more computer programs (such as dataflow graphs), which were generated by the transformation of a specification into the computer program(s) using the techniques described herein. A transform generator can transform a rule specification into the computer program that implements the segmentation logic. In this example, the selections made by an entity through user interfaces described here form a specification that specify which fields and datasets are used in the complex aggregation. Based on the specification, the transforms described herein are generated.

The data processing system 210 may be hosted on one or more general-purpose computers under the control of a suitable operating system, such as the UNIX operating system. For example, the data processing system 210 can include a multiple-node parallel computing environment including a configuration of computer systems using multiple central processing units (CPUs), either local (e.g., multiprocessor systems such as SMP computers), or locally distributed (e.g., multiple processors coupled as clusters or MPPs), or remotely distributed (e.g., multiple processors coupled via LAN or WAN networks), or any combination thereof.

In some examples, an entity includes dataflow components corresponding to nodes that are coupled by data flows corresponding to links. In this example, the computer program is a dataflow graph including entities corresponding to nodes that are coupled by data flows corresponding to links. In this example, the memory includes volatile or non-volatile memory. Additionally, in some examples, the entity includes one or more other entities.

The graph configuration approach described above can be implemented using software for execution on a computer. For instance, the software forms procedures in one or more computer programs that execute on one or more data processing systems 210, e.g., computer programmed or computer programmable systems (which may be of various architectures such as distributed, client/server, or grid) each including at least one processor, at least one data storage system (including volatile and non-volatile memory and/or storage elements), at least one input device or port, and at least one output device or port. The software may form one or more modules of a larger computer program, for example, which provides other services related to the design and configuration of dataflow graphs. The nodes and elements of the graph can be implemented as data structures stored in a computer readable medium or other organized data conforming to a data model stored in a data repository.

The software may be provided on a storage medium, such as a CD-ROM, readable by a general or special purpose programmable computer or delivered (encoded in a propagated signal) over a communication medium of a network to the computer where it is executed. All the functions may be performed on a special purpose computer, or using special-purpose hardware, such as coprocessors. The software may be implemented in a distributed manner, in which different parts of the dataflow specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the data processing system 210 to perform the procedures described herein. The data processing system 210 may also be implemented as a computer-readable storage medium, configured with a computer program, where the storage medium so configured causes the data processing system 210 to operate in a specific and predefined manner to perform the functions described herein.

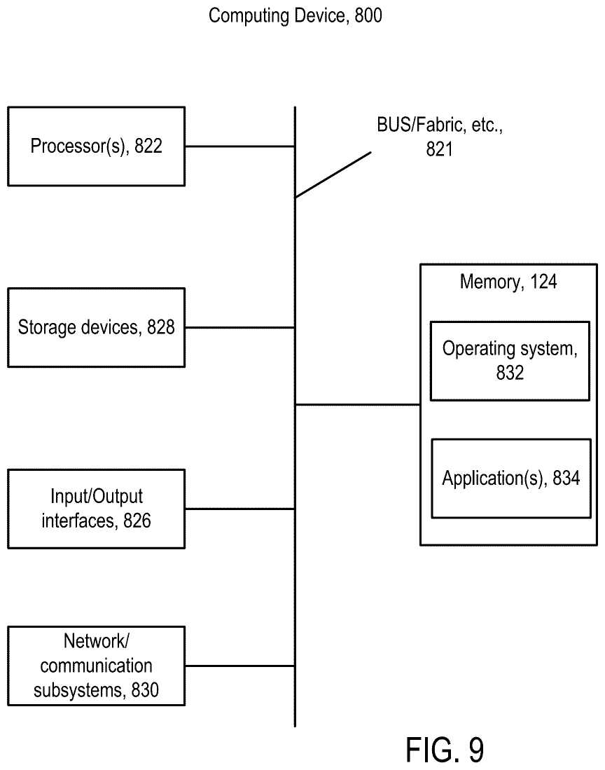

Referring to FIG. 9, an example operating environment for implementing embodiments of the present invention is shown and designated generally as computing device 800. Essential elements of a computing device 800 or a computer or data processing system or client or server are one or more programmable processors 822 for performing actions in accordance with instructions and one or more memory devices 824 for storing instructions and data. Generally, a computer will also include, or be operatively coupled, (via bus 821, fabric, network, etc.,) to I/O components 826, e.g., display devices, network/communication subsystems, etc. (not shown) and one or more mass storage devices 828 for storing data and instructions, etc., and a network communication subsystem 830, which are powered by a power supply (not shown). In memory device 824, are an operating system 832 and applications 834 for application programming.

Devices suitable for storing computer program instructions and data include all forms of non-volatile memory, media and memory devices including by way of example, semiconductor memory devices (e.g., EPROM, EEPROM, and flash memory devices), magnetic disks (e.g., internal hard disks or removable disks), magneto optical disks, and CD ROM and DVD-ROM disks. The processor and the memory can be supplemented by, or incorporated in, special purpose logic circuitry.

To provide for interaction with a user, embodiments of the subject matter described in this specification are implemented on a computer having a display device (monitor) for displaying information to the user and a keyboard, a pointing device, (e.g., a mouse or a trackball) by which the user can provide input to the computer. In addition, a computer can interact with a user by sending documents to and receiving documents from a device that is used by the user (for example, by sending web pages to a web browser on a user's user device in response to requests received from the web browser).

Embodiments of the subject matter described in this specification can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification includes many specific implementation details, these should not be construed as limitations on the scope of any inventions or of what may be claimed, but rather as descriptions of features specific to embodiments of particular inventions.

Similarly, while operations are depicted in the drawings in a particular order, this should not be understood as requiring that such operations be performed in the order shown or in sequential order, or that all illustrated operations be performed, to achieve desirable results. Moreover, the separation of various system components in the embodiments described above should not be understood as requiring such separation in all embodiments, and the described program components and systems can generally be integrated together in a single software product or packaged into multiple software products.

Several embodiments have been described. Nevertheless, it will be understood that various modifications may be made without departing from the scope of the techniques described herein. For example, some of the steps described above may be order independent, and thus can be performed in an order different from that described. Additionally, any of the foregoing techniques described regarding a dataflow graph can also be implemented and executed regarding a program. Accordingly, other embodiments are within the scope of the following claims.

1. A method implemented by a data processing system for performing real-time segmentation based on receipt of transaction data, said method including:
accessing, from a hardware storage device, one or more segmentation rules, wherein a segmentation rule specifies:
a segment that represents one or more predetermined attributes describing an entity; and
one or more conditions for associating an entity with the segment;
receiving, by the data processing system, one or more data items associated with an entity;
detecting, in the one or more received data items, transaction data indicative of occurrence of a transaction;
responsive to the detecting, accessing memory that stores data records for a plurality of entities;
retrieving, from the memory, a data record for the entity;
updating the retrieved data record in accordance with the data;
executing the one or more segmentation rules on the updated data record;
determining that the updated data record satisfies one or more conditions of at least one of the one or more segmentation rules;
based on results of the determining, associating the entity for the updated data record with one or more segments specified by the at least one of the one or more segmentation rules, with the associating being in near real-time relative to the occurrence of the transaction; and
outputting, by the data processing system, a notification of the one or more segments associated with the entity;
wherein the notification provides for performance of one or more actions for the entity in near real-time relative to the occurrence of the transaction, with the one or more actions being in accordance with one or more predetermined attributes of the one or more segments.

2. The method of claim 1, further including:
generating a push notification to instruct a transaction processing system to update the data record associated with the updated data record when at least one segment associated with the updated data record is changing from a previous segment.

3. The method of claim 1, further including:
receiving a request for a real-time segment associated with the updated data record as a service; and
in response to receiving the request and in real-time, sending the one or more segments associated with the updated data records to a system that sent the request.

4. The method of claim 1, further including:
providing a user interface for defining the one or more rules prior to determination of the one or more segments.

5. The method of claim 1, wherein the notification comprises an offer that is exclusive to one of the one or more segments.

6. The method of claim 1, further including:
determining that the updated data record is associated with at least two segments; and
generating, based on the determining, a notification for performing, by a remote computing system, at least two actions.

7. The method of claim 1, wherein updating the data record with data in accordance with the one or more data items received specifying the occurrence of the transaction includes:
accessing, from volatile memory, a batch data record associated with the updated data record, wherein the batch data record includes historic batch data;
generating a virtual record that includes at least a portion of the one or more data items received specifying the occurrence of the transaction and at least a portion of the historic batch data of the batch data record associated with the updated data record; and
determining the one or more segments associated with the updated data record based on the virtual record.

8. The method of claim 7, further comprising:
retrieving, from a data warehouse, the historic batch data and loading the retrieved historic batch data into the volatile memory.

9. The method of claim 1, wherein the determining of one or more segments associated with the updated data record is executed in response to determining that the updated record is likely to change a segment for the updated data record.

10. A data processing system for performing real-time segmentation by updating a wide record based on receipt of real-time data, wherein an item of real-time data represents a transaction, detecting that the updated wide record satisfies criteria for performing real-time segmentation, and performing real-time segmentation on the updated, wide record, wherein real-time is relative to when a transaction represented in the updated wide record occurs, including:
accessing, from a hardware storage device, one or more segmentation rules, wherein a segmentation rule specifies:
a segment that represents one or more predetermined attributes describing an entity; and
one or more conditions for associating an entity with the segment;
receiving, by the data processing system, one or more data items associated with an entity;
detecting, in the one or more received data items, transaction data indicative of occurrence of a transaction;
responsive to the detecting, accessing memory that stores data records for a plurality of entities;
retrieving, from the memory, a data record for the entity;
updating the retrieved data record in accordance with the transaction data;
executing the one or more segmentation rules on the updated data record;
determining that the updated data record satisfies one or more conditions of at least one of the one or more segmentation rules;
based on results of the determining, associating the entity for the updated data record with one or more segments specified by the at least one of the one or more segmentation rules, with the associating being in near real-time relative to the occurrence of the transaction; and
outputting, by the data processing system, a notification of the one or more segments associated with the entity;
wherein the notification provides for performance of one or more actions for the entity in near real-time relative to the occurrence of the transaction, with the one or more actions being in accordance with one or more predetermined attributes of the one or more segments.

11. The data processing system of claim 10, further including:
generating a push notification to instruct a transaction processing system to update the data record associated with the updated data record when at least one segment associated with the updated data record is changing from a previous segment.

12. The data processing system of claim 10, further including:
receiving a request for a real-time segment associated with the updated data record as a service; and
in response to receiving the request and in real-time, sending the one or more segments associated with the updated data records to a system that sent the request.

13. The data processing system of claim 10, further including:
providing a user interface for defining the one or more rules prior to determination of the one or more segments.

14. The data processing system of claim 10, wherein the notification comprises an offer that is exclusive to one of the one or more segments.

15. The data processing system of claim 10, further including:
determining that the updated data record is associated with at least two segments; and
generating, based on the determining, a notification for performing, by a remote computing system, at least two actions.

16. The data processing system of claim 10, wherein updating the data record with data in accordance with the one or more data items received specifying the occurrence of the transaction includes:
retrieving, from a data warehouse, a batch data record associated with the updated data record;
generating a virtual record that includes at least a portion of the one or more data items received specifying the occurrence of the transaction and the batch data record associated with the updated data record; and
determining the one or more segments associated with the updated data records based on the virtual record.

17. One or more computer-readable hardware storage devices for performing real-time segmentation by updating a wide record based on receipt of real-time data, wherein an item of real-time data represents a transaction, detecting that the updated wide record satisfies criteria for performing real-time segmentation, and performing real-time segmentation on the updated, wide record, wherein real-time is relative to when a transaction represented in the updated wide record occurs, including:
accessing, from a hardware storage device, one or more segmentation rules, wherein a segmentation rule specifies:
a segment that represents one or more predetermined attributes describing an entity; and
one or more conditions for associating an entity with the segment;
receiving, by the data processing system, one or more data items associated with an entity;
detecting, in the one or more received data items, transaction data indicative of occurrence of a transaction;
responsive to the detecting, accessing memory that stores data records for a plurality of entities;
retrieving, from the memory, a data record for the entity;
updating the retrieved data record in accordance with the transaction data;
executing the one or more segmentation rules on the updated data record;
determining that the updated data record satisfies one or more conditions of at least one of the one or more segmentation rules;
based on results of the determining, associating the entity for the updated data record with one or more segments specified by the at least one of the one or more segmentation rules, with the associating being in near real-time relative to the occurrence of the transaction; and
outputting, by the data processing system, a notification of the one or more segments associated with the entity;
wherein the notification provides for performance of one or more actions for the entity in near real-time relative to the occurrence of the transaction, with the one or more actions being in accordance with one or more predetermined attributes of the one or more segments.

18. The one or more computer-readable hardware storage devices of claim 17, further including:
generating a push notification to instruct a transaction processing system to update the data record associated with the updated data record when at least one segment associated with the updated data record is changing from a previous segment.

19. The one or more computer-readable hardware storage devices of claim 17, further including:
receiving a request for a real-time segment associated with the updated data record as a service; and
in response to receiving the request and in real-time, sending the one or more segments associated with the updated data records to a system that sent the request.

20. The one or more computer-readable hardware storage devices of claim 17, further including:
providing a user interface for defining the one or more rules prior to determination of the one or more segments.

21. The one or more computer-readable hardware storage devices of claim 17, wherein the notification comprises an offer that is exclusive to one of the one or more segments.

22. The one or more computer-readable hardware storage devices of claim 17, further including:
determining that the updated data record is associated with at least two segments; and
generating, based on the determining, a notification for performing, by a remote computing system, at least two actions.

23. The one or more computer-readable hardware storage devices of claim 17, wherein updating the data record with data in accordance with the one or more data items received specifying the occurrence of the transaction includes:
retrieving, from a data warehouse, a batch data record associated with the updated data record;
generating a virtual record that includes at least a portion of the one or more data items received specifying the occurrence of the transaction and the batch data record associated with the updated data record; and
determining the one or more segments associated with the updated data records based on the virtual record.

24. A method implemented by a data processing system for performing real-time segmentation by updating a data record based on receipt of real-time data, wherein an item of real-time data represents a transaction, detecting that the updated data record satisfies criteria for performing real-time segmentation, and performing real-time segmentation on the updated, data record, wherein real-time is relative to when a transaction represented in the updated data record occurs, including:
receiving, by a data processing system, one or more data items associated with a given key;
detecting, in the one or more received data items, an occurrence of a transaction;
responsive to the detecting, accessing volatile memory that stores data records for a plurality of keys;
retrieving, from the volatile memory, a data record for the given key;
updating the data record with data in accordance with the one or more data items received specifying the occurrence of the transaction and being associated with the given key;
executing one or more rules on the updated data record, with a rule being associated with a segment, with the rule specifying one or more conditions, and with the rule further specifying that upon satisfaction of the one or more conditions by data of the updated data record to associate the data record for the given key with the segment;
based on the executing, determining one or more segments associated with the updated data record, with determination of the one or more segments being in near real-time relative to the occurrence of the transaction; and
outputting, by the data processing system, instructions specifying one or more actions associated with the one or more segments determined.
